(19) United States
(12) Patent Application Publication
(10) Pub. No.: US 2022/0113086 A1
(43) Pub. Date: Apr. 14, 2022

(54) INTEGRATED MODULAR SYSTEM FOR TRANSFER, STORAGE, AND DELIVERY OF LIQUEFIED NATURAL GAS (LNG)

(71) Applicant: GALILEO TECHNOLOGIES CORP., Arcadia, CA (US)

(72) Inventor: Osvaldo DEL CAMPO, Buenos Aires (AR)

(21) Appl. No.: 17/497,258

(22) Filed: Oct. 8, 2021

Related U.S. Application Data
(60) Provisional application No. 63/091,224, filed on Oct. 13, 2020.

(51) Int. Cl. F25J 1/00; B63B 25/16; F25J 1/02; F17C 1/00; F17C 5/04

(52) U.S. Cl. CPC F25J 1/0025; B63B 25/16; F25J 1/0277; F17C 2223/0161; F17C 1/002; F17C 5/04; F17C 2221/033; F25J 1/0262

(57) ABSTRACT

A liquefied natural gas (LNG) management system that stores natural gas in a liquefied state in an isothermal storage tank. A modular multi-fueling platform is in fluid communication with the isothermal storage tank. The modular multi-fueling platform includes a LNG conditioning tank, a compressor, a heat exchanger, a heater, plumbing, associated valves, various sensing transmitters, and a programmable logic computer (PLC). Data acquired by the PLC determines actions by the modular multi-fueling platform, including operation of valves, the compressor, etc. The system transfers LNG between the storage tank, the conditioning tank, and a cargo tank (consumer's vehicle tank). The system employs steps of heating and compressing the LNG and boil off gas to maintain the LNG at temperature. The system employs pressure differences for transferring the LNG between tanks.

### CROSS-REFERENCE TO RELATED APPLICATION

This Non-Provisional Utility Patent application claims the benefit of United States Provisional Patent Application Ser. No. 63/091,224, filed on Oct. 13, 2020, which is incorporated herein in its entirety.

### FIELD OF THE INVENTION

The present invention relates generally to the compression and liquefaction of gases, and more particularly to an integrated modular system for storing, handling, shipping, delivering, measurement and re-liquefaction of liquefied natural gas (LNG). The present system provides the partial liquefaction of boil-off by utilizing an expansion process. The apparatus and process are exclusive of refrigerants.

### DESCRIPTION OF RELATED ART

Natural gas is a naturally occurring hydrocarbon gas mixture consisting primarily of methane, and commonly includes varying amounts of other higher alkanes. Natural gas can also include a small percentage of at least one of carbon dioxide, nitrogen, hydrogen sulfide, or helium. Natural gas is formed when layers of decomposing plant and animal matter are exposed to intense heat and pressure under the surface of the Earth over millions of years. The energy that the plants originally obtained from the sun is stored in the form of chemical bonds in the gas.

Natural gas is composed primarily of methane, although it also contains ethane, propane, and traces of other gases. Depending on where it is extracted, the composition of natural gas varies between 87% and 96% methane with about 1.5% to 5% ethane, and 0.1% to 1.5% propane.

Natural gas is a known alternative to combustion fuels such as gasoline and diesel. Much effort has gone into the development of natural gas as an alternative combustion fuel in order to combat various drawbacks of gasoline and diesel including production costs and the subsequent emissions created by the use thereof. As is known in the art, natural gas is a cleaner burning fuel than other combustion fuels.

There are two common formats for the commercialization of natural gas: compressed natural gas (CNG) and liquefied natural gas (LNG). CNG is made by compressing natural gas to less than 1% of its volume at standard atmospheric pressure. Consisting mostly of methane, CNG is odorless, colorless and tasteless. It is drawn from domestically drilled natural gas wells or in conjunction with crude oil production.

Compressed natural gas (CNG) is a cleaner and also cheaper alternative to other automobile fuels such as gasoline (petrol). By the end of 2014 there were over 20 million natural gas vehicles worldwide, led by Iran (3.5 million), China (3.3 million), Pakistan (2.8 million), Argentina (2.5 million), India (1.8 million), and Brazil (1.8 million). The energy efficiency is generally equal to that of gasoline engines, but lower compared with modern diesel engines. Gasoline vehicles that are converted to run on natural gas suffer because of the low compression ratio of their engines. The lower compression ration results in a cropping of delivered power while running on natural gas by approximately 10 to 15 percent. Engines specifically designed and manufactured to operate on compressed natural gas (CNG) employ a higher compression ratio optimizing the fuel's higher octane number of 120 to 130.

Besides use in road vehicles, compressed natural gas (CNG) can also be used in aircraft. Compressed natural gas (CNG) has been used in some aircraft like the Aviat Aircraft Husky 200 CNG and the Chromarat VX-1 KittyHawk.

Liquefied natural gas (LNG) is also being used in aircraft. Russian aircraft manufacturer Tupolev for instance is running a development program to produce LNG-powered and hydrogen-powered aircraft. The program has been running since the mid-1970s, and seeks to develop LNG and hydrogen variants of the Tu-204 and Tu-334 passenger aircraft, and also the Tu-330 cargo aircraft. Depending on the current market price for jet fuel and LNG, fuel for an LNG-powered aircraft could cost 5,000 rubles (US $100) less per tonne, roughly 60%, with considerable reductions to carbon monoxide, hydrocarbon and nitrogen oxide emissions.

The advantages of liquid methane as a jet engine fuel are that it has more specific energy than the standard kerosene mixes do and that its low temperature can help cool the air which the engine compresses for greater volumetric efficiency, in effect replacing an intercooler. Alternatively, it can be used to lower the temperature of the exhaust.

Liquefied natural gas (LNG) is natural gas that is cooled to −260° Fahrenheit until it becomes a liquid and then stored at essentially atmospheric pressure. Converting natural gas to liquefied natural gas (LNG), a process that reduces its volume by about 600 times, allows it to be transported. Once delivered to its destination, the liquefied natural gas (LNG) is warmed back into its original gaseous state so that it can be used just like existing natural gas supplies, by sending it through pipelines for distribution to homes and businesses.

When returned to its gaseous state, liquefied natural gas (LNG) is used across the residential, commercial and industrial sectors for purposes as diverse as heating and cooling homes, cooking, generating electricity and manufacturing paper, metal, glass and other materials. Liquefied natural gas (LNG) is also increasingly being used to fuel heavy-duty vehicles.

More and more heavy-duty vehicles are moving to Liquefied natural gas (LNG) as a fuel of choice. Using Liquefied natural gas (LNG) and natural gas to fuel vehicles reduces greenhouse gas emissions by 30 percent versus conventional liquid fuels in accordance with the US Department of Energy.

Liquefied natural gas (LNG) requires only 30 percent of the space of compressed natural gas (CNG) to store the same amount of energy. In order to keep the liquefied natural gas (LNG) cold, liquefied natural gas (LNG) is stored on-board vehicles in thermally insulated storage tanks. When the engine in natural gas vehicle (NGV) is started, the liquefied natural gas (LNG) is heated, converting it back to a gas. From that point on, the fuel supply process is similar to the system on compressed natural gas (CNG) fueled engines.

The advantages of these two fuels, compressed natural gas (CNG) and liquefied natural gas (LNG), are clear: cleaner emissions, reducing dependence on foreign oil and most importantly the price at the pump. Natural gas prices tend to run about $1.50 to $2 per diesel-gallon-equivalent less than diesel, and historically have been less volatile. For a lot of companies, that difference in price is more than attractive enough to make up for the higher up-front cost of a natural gas truck.

Then, it is difficult to understand why not more Americans are driving natural gas cars. The U.S. is the largest natural gas producer in the world. If it could figure out a way to use that abundant fuel in automobiles it could reduce oil dependency, give drivers more choices and reduce air pollution. There are very few personal vehicles that run on compressed natural gas (CNG), and hardly any refueling stations at which to gas up. Auto companies do not want to build compressed natural gas (CNG) vehicles if people do not have a place to refuel, and no company is going to build a compressed natural gas (CNG) refueling station without any customers.

Costs of installing natural gas infrastructure are also expensive. It differs based on size, capacity, and the type of natural gas (LNG, CNG, or both) it dispenses. It also varies in the way the natural gas is dispensed (fast-fill, time-fill). According to a 2014 report published by the National Renewable Energy Laboratory for the U.S. Department of Energy, costs for installing a compressed natural gas (CNG) fueling station can range up to $1.8 million depending on the size and application, and a liquefied natural gas (LNG) fueling site can range from $1 million to $4 million. With these investment volumes and the low volume of clients it is easy to understand why it is still not massive.

However, there are also important environmental issues with the present technology used in CNG/LNG stations. Present liquefied natural gas (LNG) stations do not have enough clients to have a regular flow of liquefied natural gas (LNG) delivered to the customers. Since liquefied natural gas (LNG) is stored at −260° Fahrenheit and the tanks that contain it are not perfectly adiabatic, the gas has the tendency to balance its temperature with the outside temperature, and thus is heated over time. The liquefied natural gas (LNG) storage has a major challenge due to the inherent heat input from the environment. The effect of the heat input is the warming of the cryogenic fluid:
a) If (constant volume) Pressure increase in the storage vessel; or
b) If (constant pressure) Fluid boils and “boil-off” vapors are released from the vessel (venting).

The vapors created due to the ambient heat input (while maintaining constant pressure in the storage vessel) are called “boil-off”. The discharge of these vapors out of the storage container is called venting. The boil-off is inherent to the storage of liquefied natural gas (LNG) due to the heat input from the ambient. Once a certain maximum pressure is reached, an automatic vent valve opens and lets out the gas until the pressure returns to the acceptable value. Boil-off produces not only an environmental issue but also significant economic loses to the owner of the gas station. Regular liquefied natural gas (LNG) stations lose around 1.5-2% of the total gas volume because of boil-off, which produces a polluting effect on the atmosphere that limits the applications of this fuel in mass markets.

From the above, there is still a need in the market for an affordable, cost-effective and versatile CNG/LNG station capable of providing an affordable solution to the CNG/LNG market without polluting the environment.

Therefore, the present invention is directed to a method and apparatus for the liquefaction of natural gas that overcomes the difficulties and drawbacks of the devices of the prior art.

### BRIEF SUMMARY OF THE INVENTION

This invention is directed to a system that provides an affordable, cost-effective and versatile compressed natural gas/liquefied natural gas (CNG/LNG) station capable of providing an affordable solution to the CNG/LNG market without polluting the environment.

In one aspect, the modular multi-fueling platform includes:
a liquefied natural gas (LNG) conditioning tank;
a compressor;
plumbing;
a plurality of valves;
a programmable logic controller (PLC);
at least one pressure sensing transmitter; and
at least one temperature sensing transmitter,

wherein the compressor is arranged in fluid communication between a liquefied natural gas (LNG) storage Isotank assembly and the LNG conditioning tank,

wherein valves are arranged to control flow between the LNG storage Isotank assembly and the conditioning tank,

wherein the at least one pressure sensing transmitter and the at least one temperature sensing transmitter are locating to obtain a pressure and a temperature and provide the pressure and the temperature to the PLC,

wherein the PLC is programmed to operate the compressor and one or more valves of the plurality of valves to convert boil off gas to liquefied natural gas (LNG) and to create a pressure differential between two tanks to transfer liquefied natural gas (LNG) from a first tank to a second tank, wherein the first tank is one of the LNG storage Isotank assembly, the LNG conditioning tank, and a cargo tank.

In a second aspect, the modular multi-fueling platform comprises at least one user input component, wherein each of the at least one user input component is in signal communication with the PLC.

In another aspect, the modular multi-fueling platform comprises at least one display, wherein the display is in signal communication with the PLC.

In yet another aspect, the liquefied natural gas (LNG) storage Isotank assembly includes:
a pressurized liquid container, and
a thermally insulating material arranged to minimize thermal release from LNG stored within the LNG storage Isotank assembly.

In yet another aspect, the liquefied natural gas (LNG) storage Isotank assembly includes:
a tubular sidewall,
a first end wall,
a second end wall,
wherein the first end wall is assembled to a first end of the tubular sidewall and the second end wall is assembled to a second end of the tubular sidewall forming the pressurized liquid container.

In yet another aspect, the tubular sidewall is a cylindrically shaped tubular sidewall.

In yet another aspect, the modular multi-fueling platform additionally includes:
a heat exchanger; and
a heating element,
wherein the heating element is arranged to provide heat to the heat exchanger,
wherein the heat exchanger is arranged to provide heat to boil off gas (BOG) extracted from at least one of the LNG storage Isotank assembly and the LNG conditioning tank.

These and other aspects, features, and advantages of the present invention will become more readily apparent from the attached drawings and the detailed description of the preferred embodiments, which follow.

### BRIEF DESCRIPTION OF THE SEVERAL VIEWS OF THE DRAWINGS

The preferred embodiments of the invention will hereinafter be described in conjunction with the appended drawings provided to illustrate and not to limit the invention, where like designations denote like elements, and in which:

FIG. 1 presents a front, side isometric view of an exemplary liquefied natural gas (LNG) and compressed natural gas (CNG) storage, processing, and delivery system in accordance with the present invention, the system including an exemplary modular multi-fueling platform in fluid communication with an exemplary liquid natural gas (LNG) storage Isotank assembly;

FIG. 2 presents a front, elevation view of the exemplary modular multi-fueling platform, originally introduced in FIG. 1;

FIG. 3 presents a front, elevation view of the exemplary modular multi-fueling platform, originally introduced in FIG. 1, the illustration presenting the modular multi-fueling platform where an enclosure is removed;

FIG. 4 presents a front, right side isometric view of the exemplary modular multi-fueling platform, originally introduced in FIG. 1;

FIG. 5 a front, right side isometric view of the exemplary modular multi-fueling platform, originally introduced in FIG. 1, the illustration presenting the modular multi-fueling platform where the enclosure is removed;

FIG. 6 presents a right side elevation view of the exemplary modular multi-fueling platform, originally introduced in FIG. 1;

FIG. 7 a right side elevation view of the exemplary modular multi-fueling platform, originally introduced in FIG. 1, the illustration presenting the modular multi-fueling platform where the enclosure is removed;

FIG. 8 presents a front, left side isometric view of the exemplary modular multi-fueling platform, originally introduced in FIG. 1;

FIG. 9 a front, left side isometric view of the exemplary modular multi-fueling platform, originally introduced in FIG. 1, the illustration presenting the modular multi-fueling platform where the enclosure is removed;

FIG. 10 presents a left side elevation view of the exemplary modular multi-fueling platform, originally introduced in FIG. 1;

FIG. 11 a left side elevation view of the exemplary modular multi-fueling platform, originally introduced in FIG. 1, the illustration presenting the modular multi-fueling platform where the enclosure is removed;

FIG. 12 presents a rear, elevation view of the exemplary modular multi-fueling platform, originally introduced in FIG. 1;

FIG. 13 presents a rear, elevation view of the exemplary modular multi-fueling platform, originally introduced in FIG. 1, the illustration presenting the modular multi-fueling platform where the enclosure is removed;

FIG. 14 presents a first exemplary operational schematic of the modular multi-fueling platform introduced in FIG. 1;

FIG. 15 presents a second exemplary operational schematic of the modular multi-fueling platform introduced in FIG. 1;

FIG. 16A presents a first portion of an operational schematic of the exemplary LNG/CNG storage, processing, and delivery system originally introduced in FIG. 1, the first portion being located in an upper left region of an overall schematic layout with connectivity being provided by letters being shown in an upper portion of each divided hexagonal connecting reference and each respective connecting FIG. identifier being shown in a lower portion of the divided hexagonal connecting reference;

FIG. 16B presents a second portion of the operational schematic of the exemplary LNG/CNG storage, processing, and delivery system originally introduced in FIG. 1, the second portion being located in an upper centered region of the overall schematic layout with connectivity being provided by letters being shown in an upper portion of each divided hexagonal connecting reference and each respective connecting FIG. identifier being shown in a lower portion of the divided hexagonal connecting reference;

FIG. 16C presents a third portion of the operational schematic of the exemplary LNG/CNG storage, processing, and delivery system originally introduced in FIG. 1, the third portion being located in an upper left region of the overall schematic layout with connectivity being provided by letters being shown in an upper portion of each divided hexagonal connecting reference and each respective connecting FIG. identifier being shown in a lower portion of the divided hexagonal connecting reference;

FIG. 16D presents a fourth portion of the operational schematic of the exemplary LNG/CNG storage, processing, and delivery system originally introduced in FIG. 1, the fourth portion being located in an lower right region of the overall schematic layout with connectivity being provided by letters being shown in an upper portion of each divided hexagonal connecting reference and each respective connecting FIG. identifier being shown in a lower portion of the divided hexagonal connecting reference;

FIG. 16E presents a fifth portion of the operational schematic of the exemplary LNG/CNG storage, processing, and delivery system originally introduced in FIG. 1, the fifth portion being located in an lower central region of the overall schematic layout with connectivity being provided by letters being shown in an upper portion of each divided hexagonal connecting reference and each respective connecting FIG. identifier being shown in a lower portion of the divided hexagonal connecting reference;

FIG. 16F presents a sixth portion of the operational schematic of the exemplary LNG/CNG storage, processing, and delivery system originally introduced in FIG. 1, the sixth portion being located in an lower right region of the overall schematic layout with connectivity being provided by letters being shown in an upper portion of each divided hexagonal connecting reference and each respective connecting FIG. identifier being shown in a lower portion of the divided hexagonal connecting reference;

FIG. 16G presents a seventh portion of the operational schematic of the exemplary LNG/CNG storage, processing, and delivery system originally introduced in FIG. 1, the seventh portion having connectivity provided by the letter V and a respective numerical identifier being shown in an irregular pentagonal (house shaped) connecting reference;

FIG. 16H presents an eighth portion of the operational schematic of the exemplary LNG/CNG storage, processing, and delivery system originally introduced in FIG. 1, the eighth portion introducing a typical compressor frequency driver;

FIG. 17 presents a process equipment table defining operating characteristics of various components included in the operational schematic of the exemplary LNG/CNG storage, processing, and delivery system originally introduced in FIG. 1, the ninth portion introducing a process equipment table;

FIG. 18 presents a component legend for components included in the schematic of the operational schematic of the exemplary LNG/CNG storage, processing, and delivery system originally introduced in FIG. 1;

FIG. 19 presents a piping legend identifying different piping functions included in the schematic of the operational schematic of the exemplary LNG/CNG storage, processing, and delivery system originally introduced in FIG. 1;

FIG. 20 presents exemplary cargo tank connections of the exemplary LNG/CNG storage, processing, and delivery system originally introduced in FIG. 1;

FIG. 21 presents various monitoring indicators included in the schematic of the operational schematic of the exemplary LNG/CNG storage, processing, and delivery system originally introduced in FIG. 1;

FIG. 22 presents an exemplary operational process overview flow diagram of the operation of the LNG/CNG storage, processing, and delivery system originally introduced in FIG. 1;

FIG. 23 presents an exemplary flow diagram detailing steps of a vehicle tank (TAC) to system connection process of the exemplary operational process overview flow diagram originally introduced in FIG. 22;

FIG. 24 presents an exemplary flow diagram detailing steps of a storage tank to conditioning tank (TAC) transfer process of the exemplary operational process overview flow diagram originally introduced in FIG. 22;

FIG. 25 presents an exemplary flow diagram detailing steps of a liquefied natural gas (LNG) conditioning process of the exemplary operational process overview flow diagram originally introduced in FIG. 22;

FIG. 26 presents an exemplary flow diagram detailing steps of a conditioning tank (TAC) pressurizing process of the exemplary operational process overview flow diagram originally introduced in FIG. 22;

FIG. 27A presents an exemplary flow diagram detailing steps of a first portion of a vehicle tank (TAC) and storage tank equalization process of the exemplary operational process overview flow diagram originally introduced in FIG. 22;

FIG. 27B presents an exemplary flow diagram detailing steps of a second or a continuing portion of the vehicle tank (TAC) and storage tank equalization process of the process initiated in FIG. 27A;

FIG. 28 presents an exemplary flow diagram detailing steps of a vehicle tank (TAV) charging process under a first set of vehicle tank conditions of the exemplary operational process overview flow diagram originally introduced in FIG. 22;

FIG. 29A presents an exemplary flow diagram detailing steps of a first portion of a vehicle tank (TAV) charging process under a second set of vehicle tank conditions of the exemplary operational process overview flow diagram originally introduced in FIG. 22;

FIG. 29B presents an exemplary flow diagram detailing steps of a second portion of a vehicle tank (TAV) charging process under a second set of vehicle tank conditions of the process initiated in FIG. 29A;

FIG. 30 presents an exemplary flow diagram detailing steps of a vehicle tank (TAV) charging process under a third set of vehicle tank conditions of the exemplary operational process overview flow diagram originally introduced in FIG. 22; and

FIG. 31 presents an exemplary flow diagram detailing steps of a supply tank to storage tank process of the exemplary operational process overview flow diagram originally introduced in FIG. 22.

Like reference numerals refer to like parts throughout the several views of the drawings.

### DETAILED DESCRIPTION OF THE INVENTION

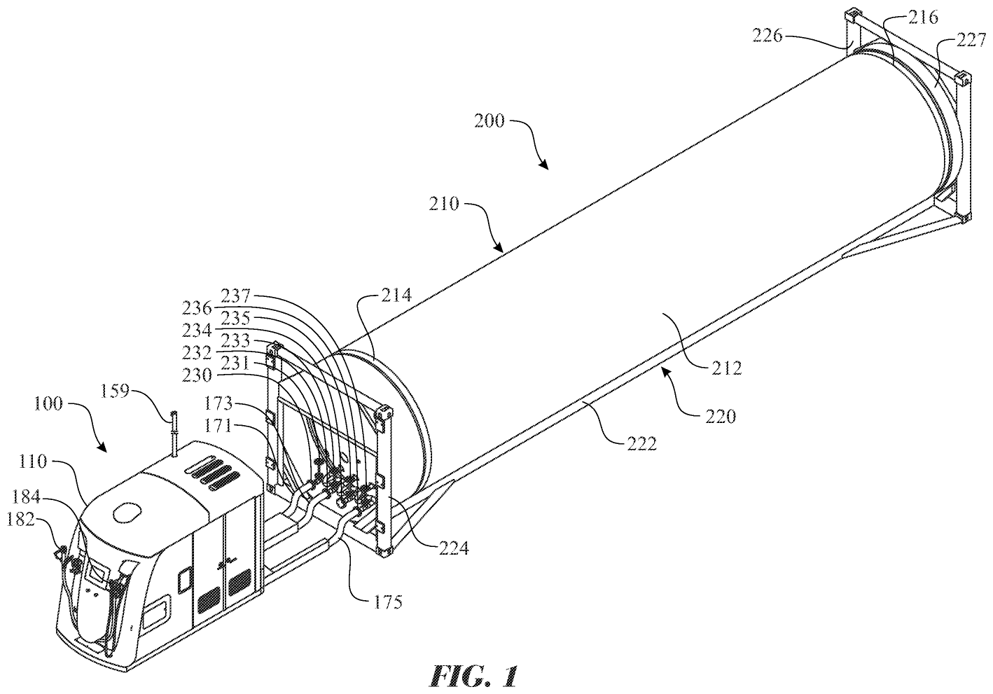

Detailed embodiments of the present invention are disclosed herein. It will be understood that the disclosed embodiments are merely exemplary of the invention that may be embodied in various and alternative forms. The figures are not necessarily to scale, and some features may be exaggerated or minimized to show details of particular embodiments, features, or elements. Specific structural and functional details, dimensions, or shapes disclosed herein are not limiting but serve as a basis for the claims and for teaching a person of ordinary skill in the art the described and claimed features of embodiments of the present invention. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Furthermore, there is no intention to be bound by any expressed or implied theory presented in the preceding technical field, background, brief summary or the following detailed description. It is also to be understood that the specific devices illustrated in the attached drawings, and described in the following specification, are simply exemplary embodiments of the inventive concepts defined in the appended claim. Hence, specific dimensions and other physical characteristics relating to the embodiments disclosed herein are not to be considered as limiting, unless the claims expressly state otherwise.

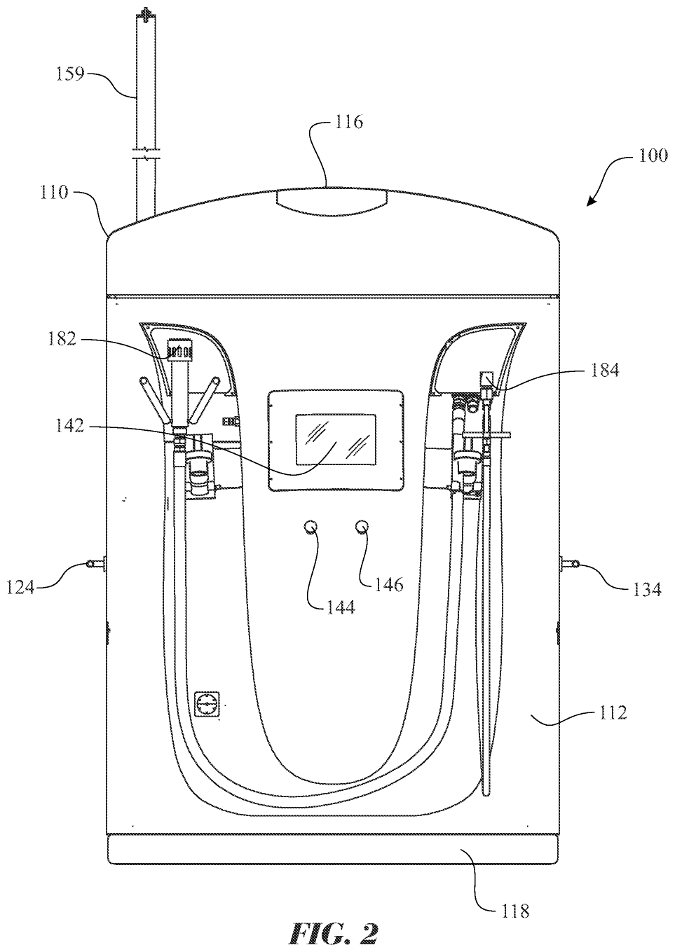

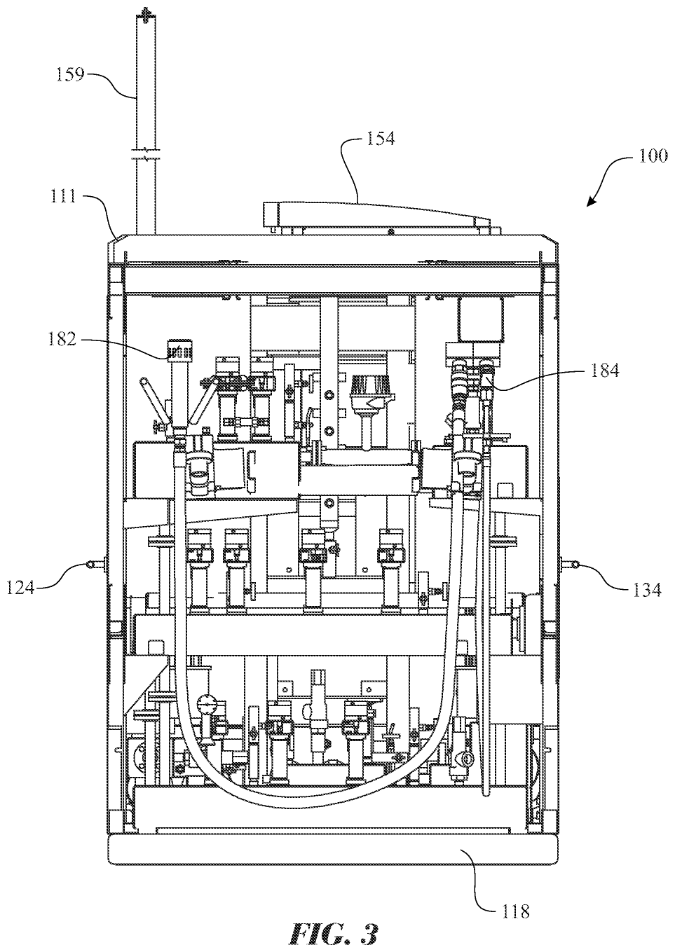

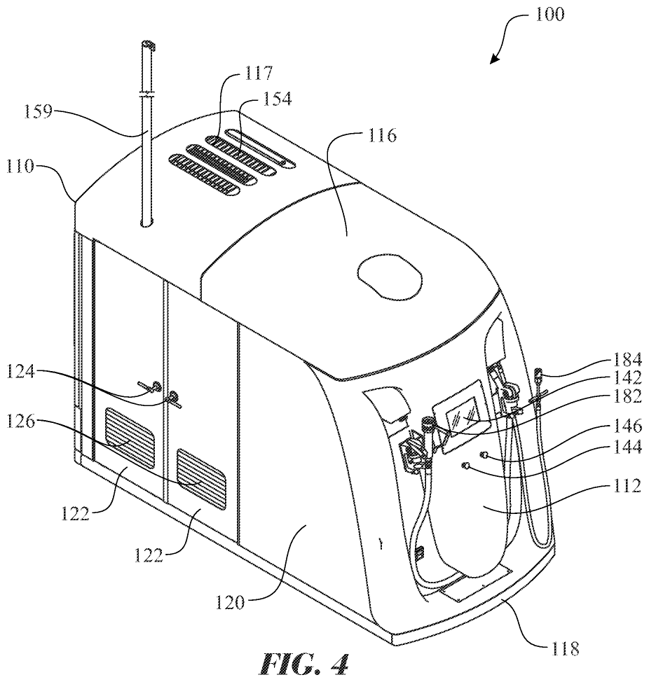

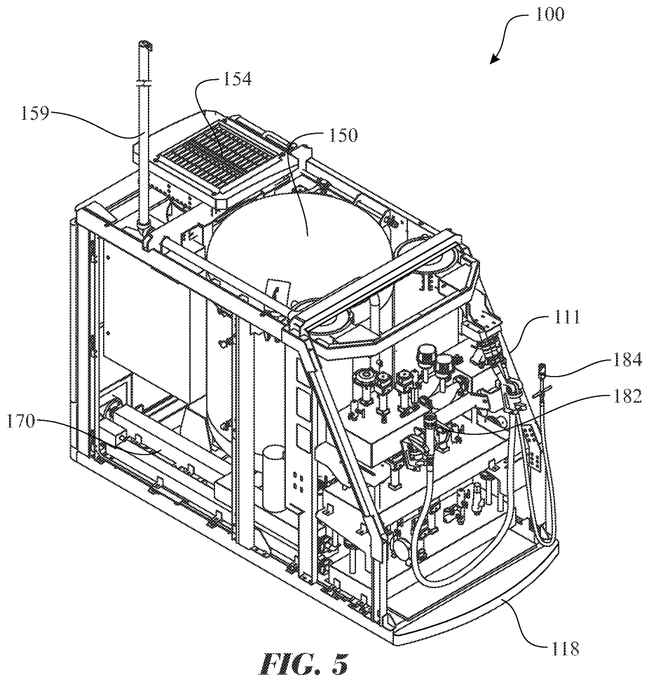

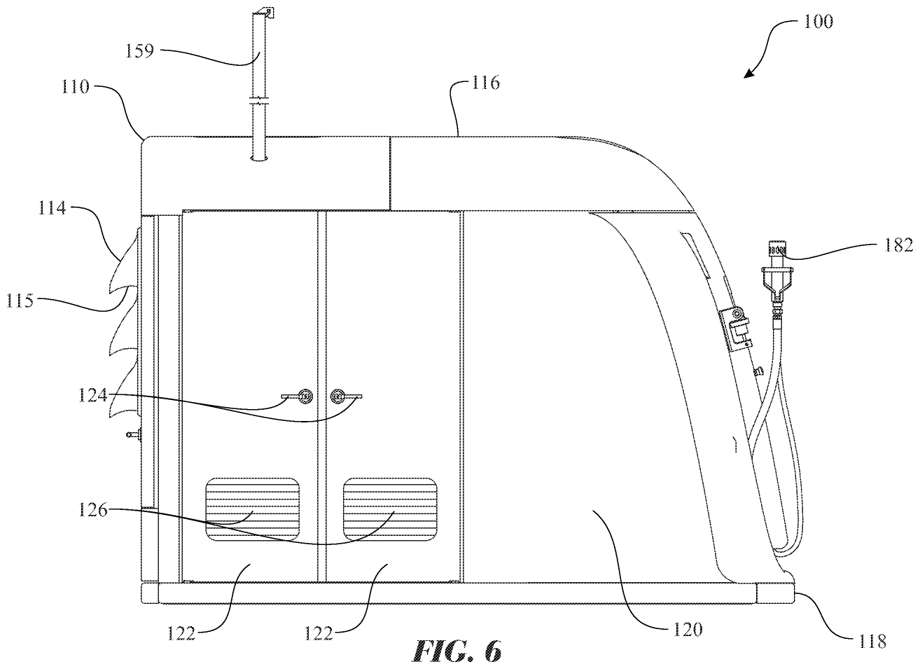

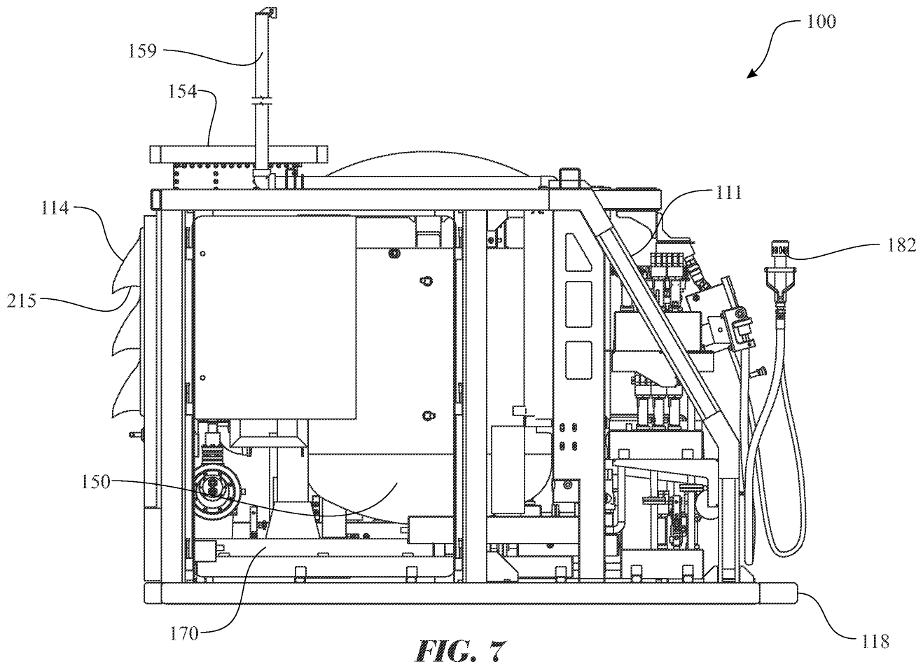

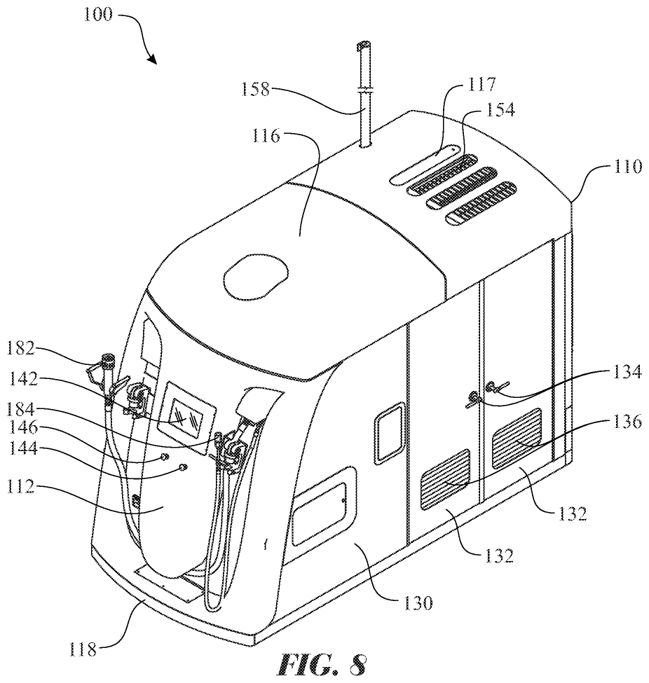

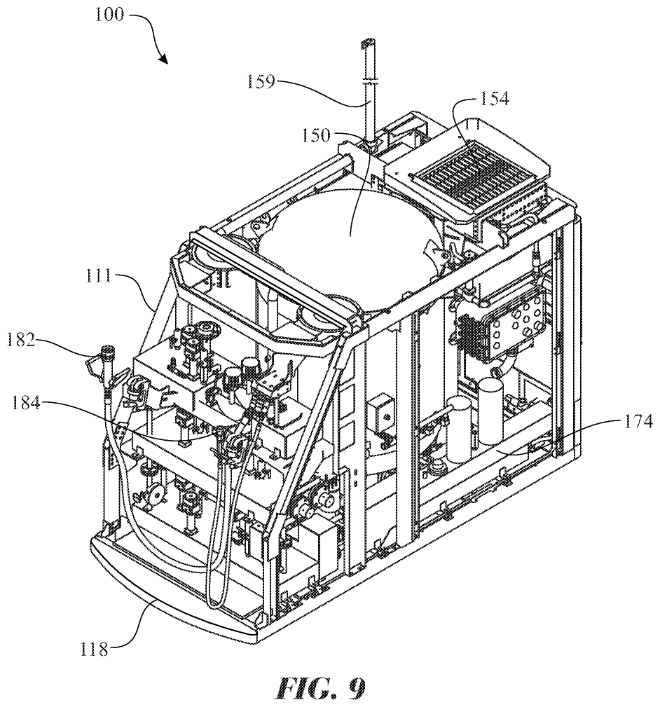

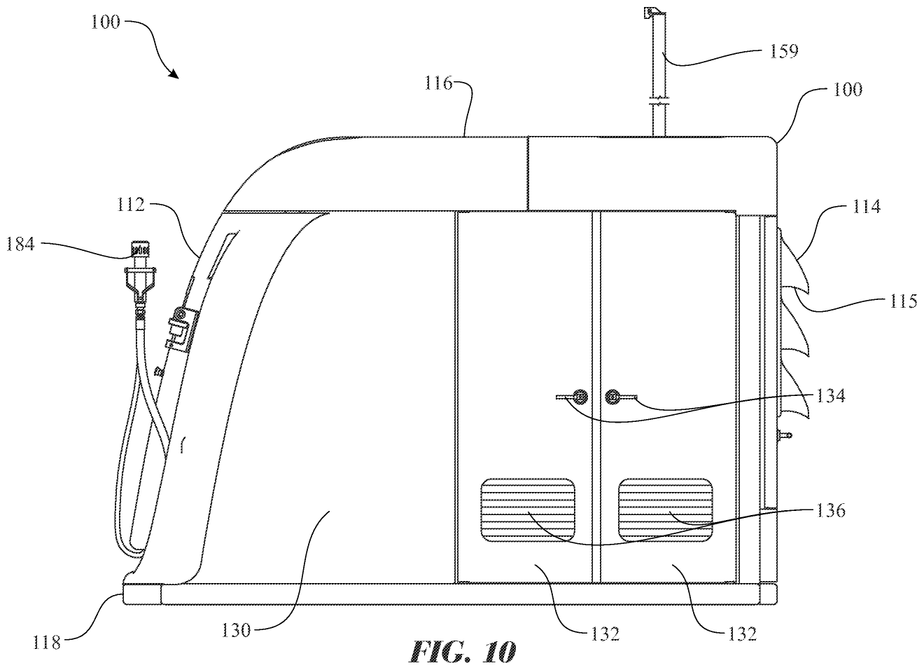

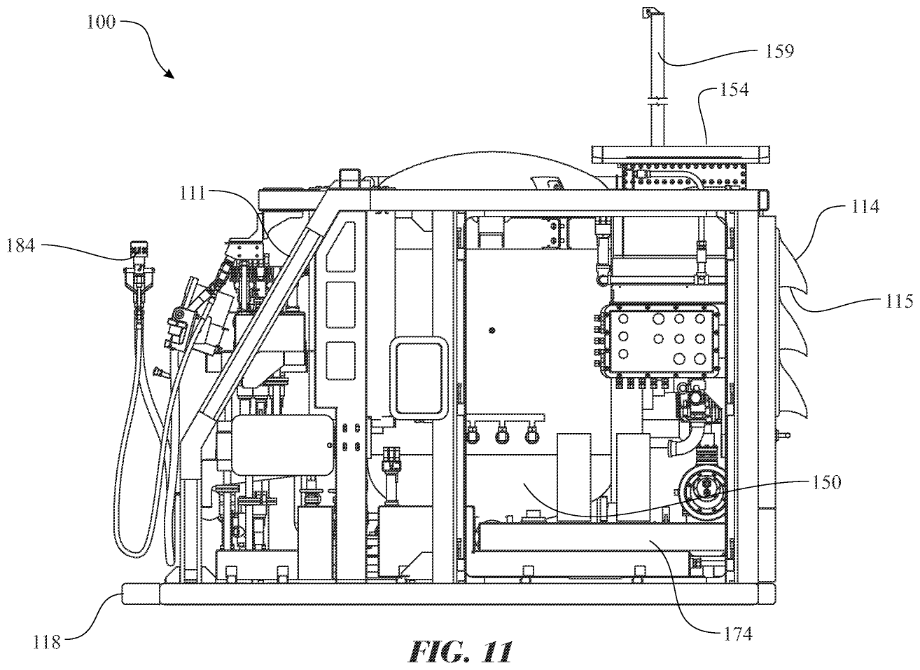

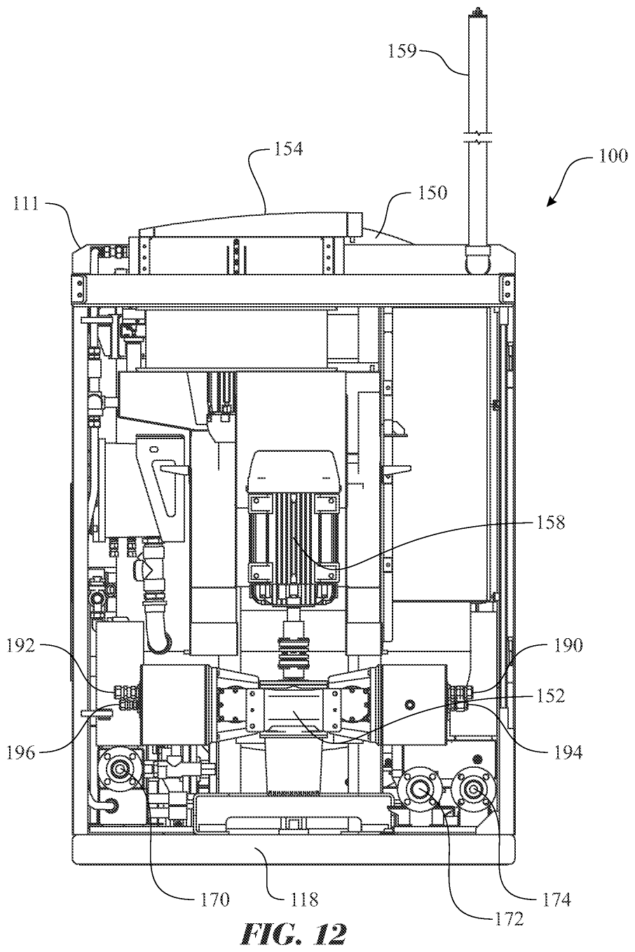

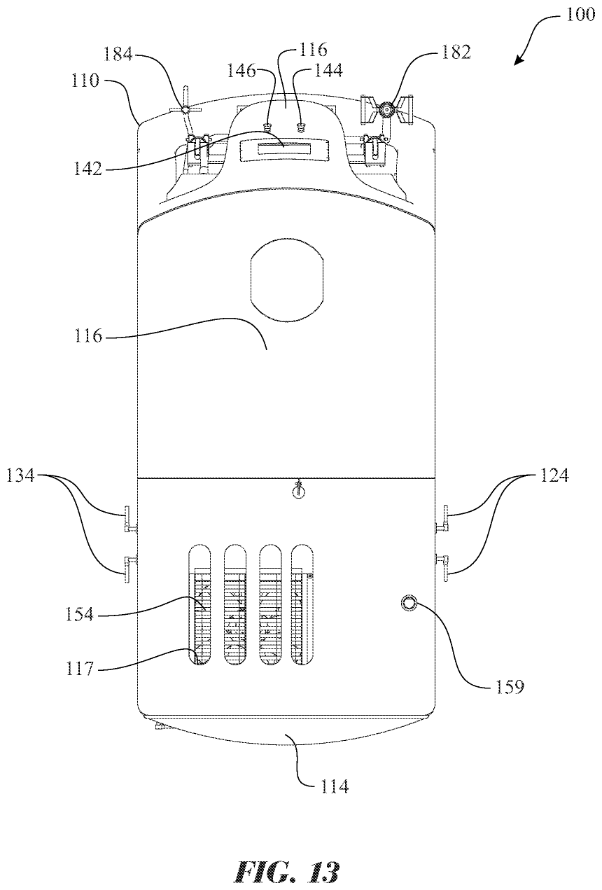

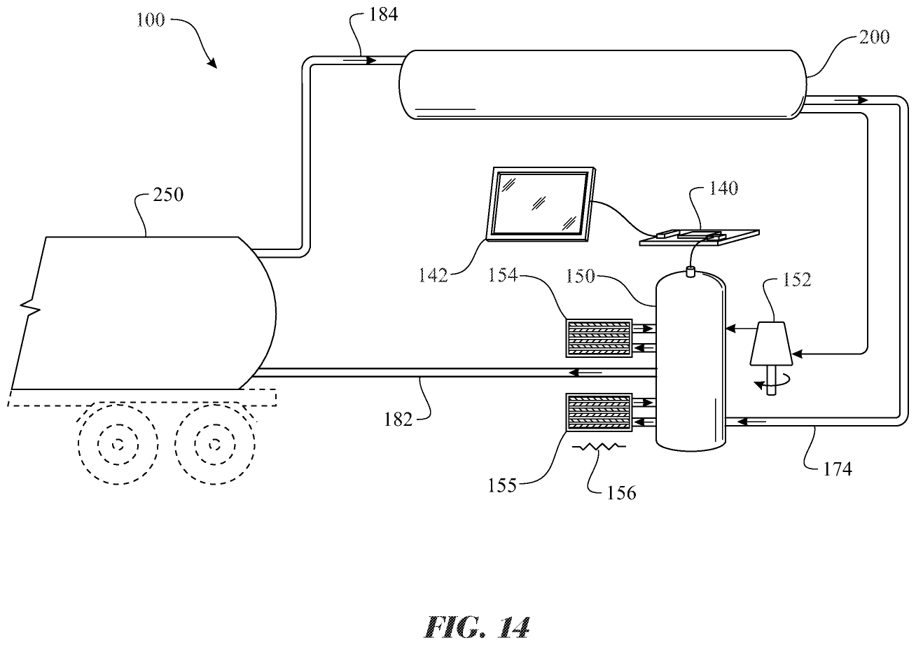

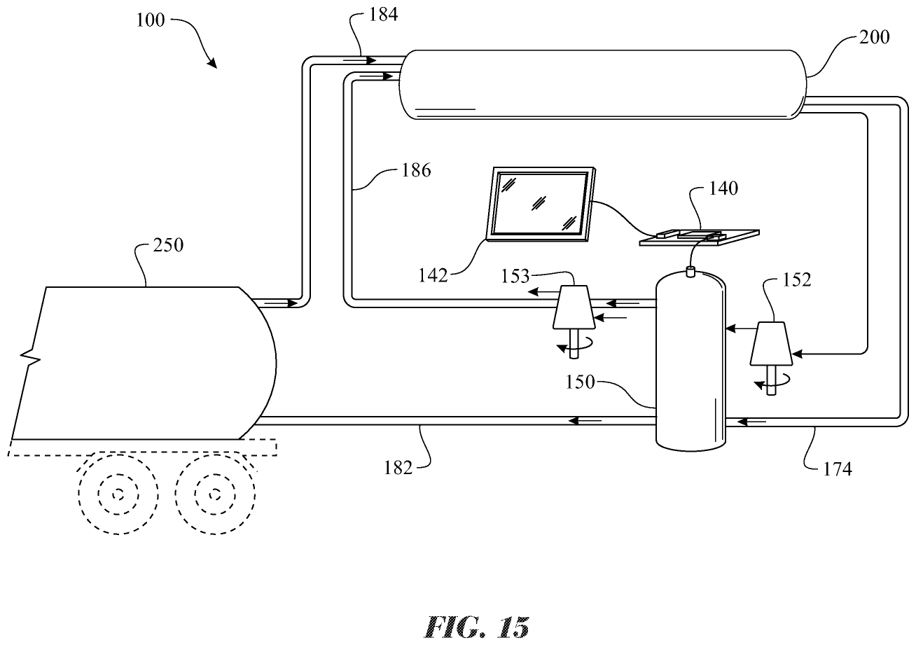

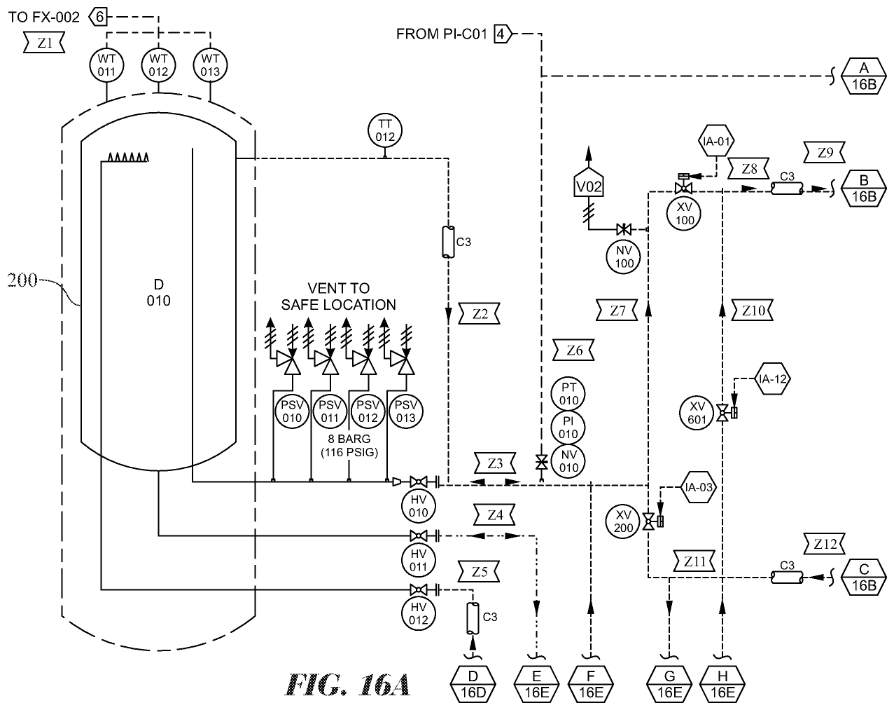

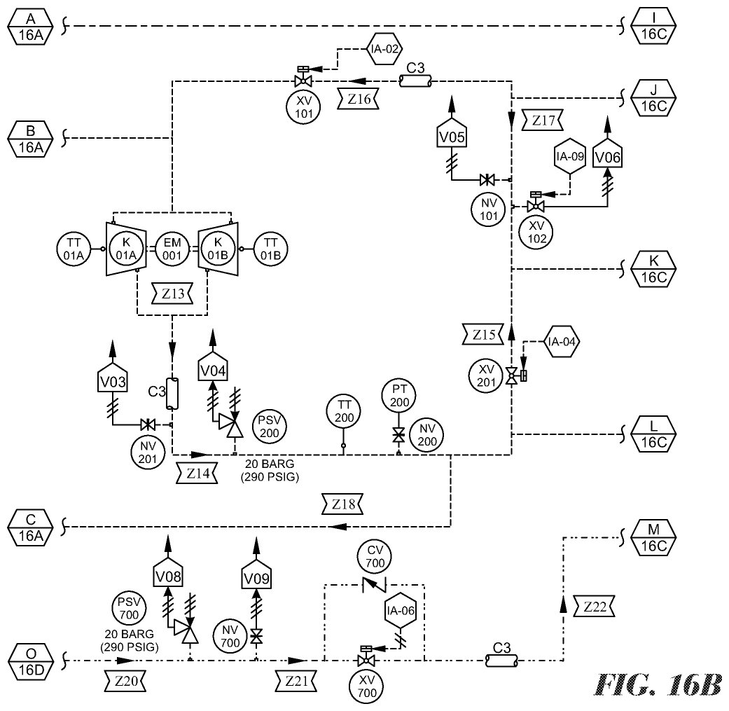

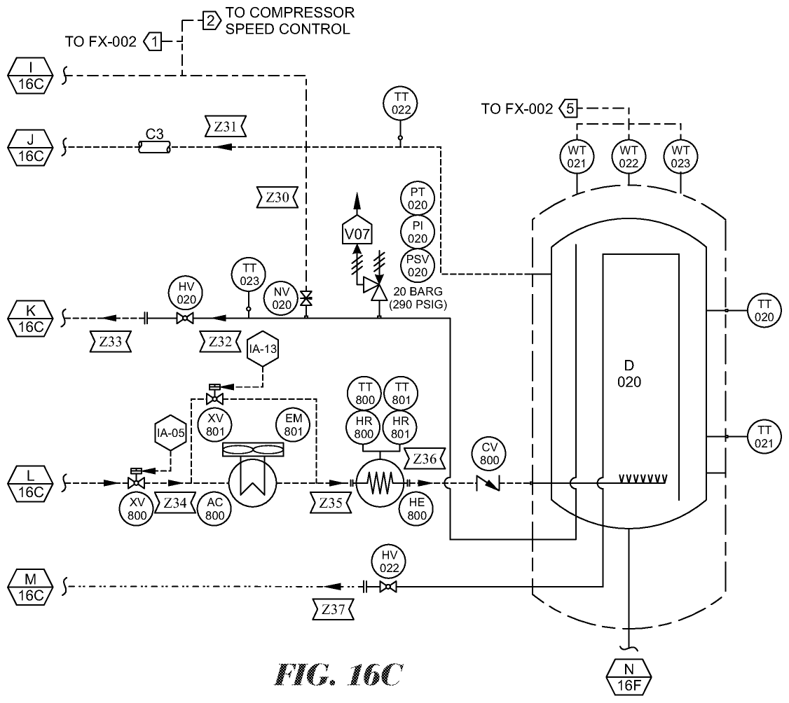

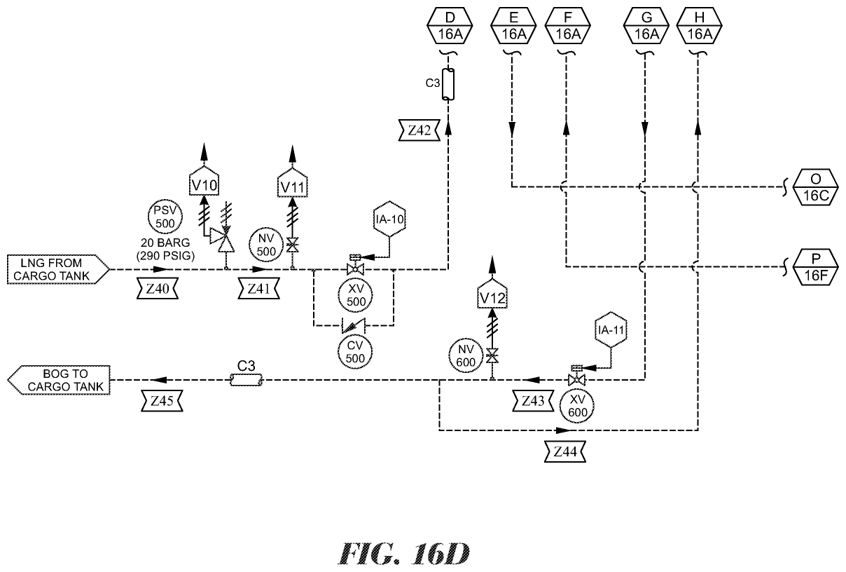

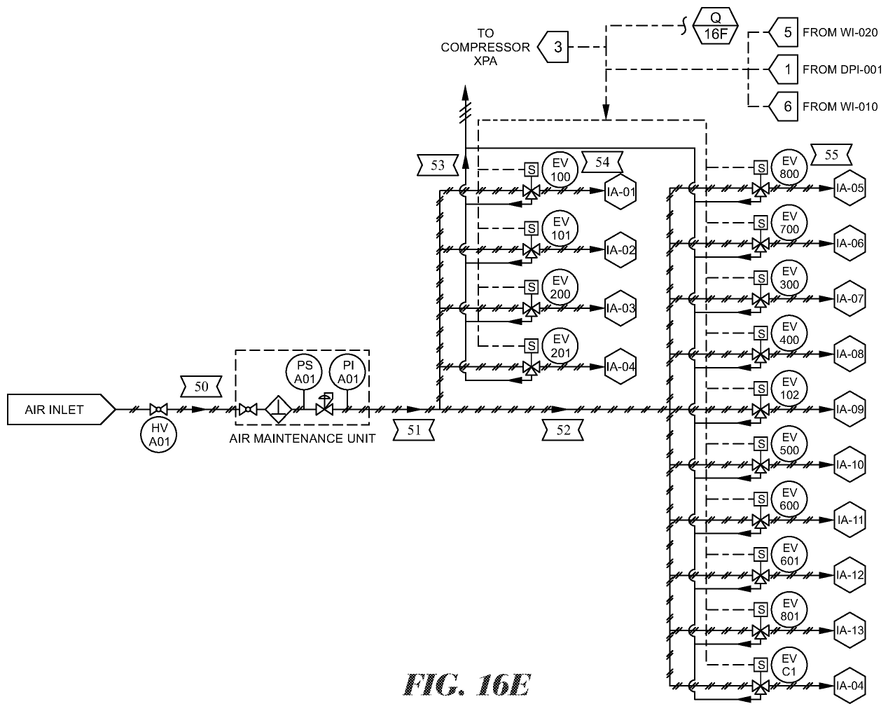

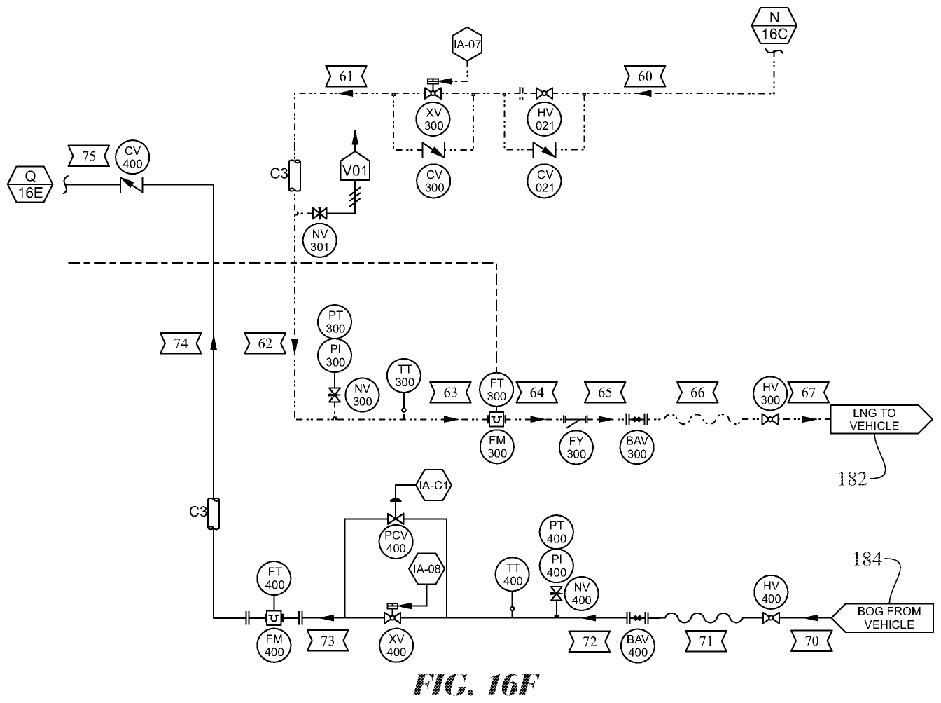

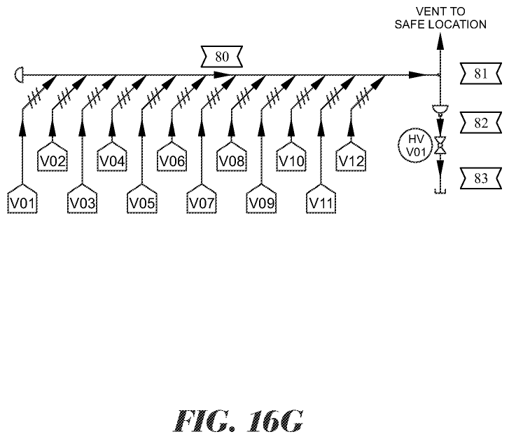

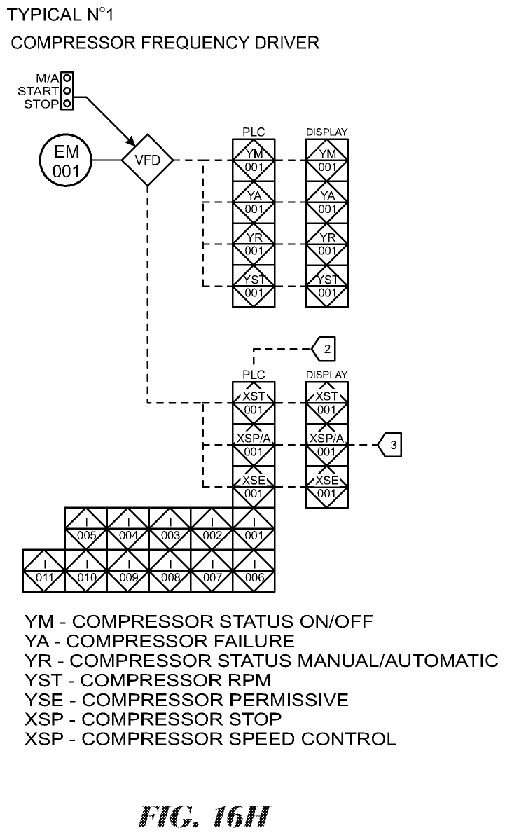

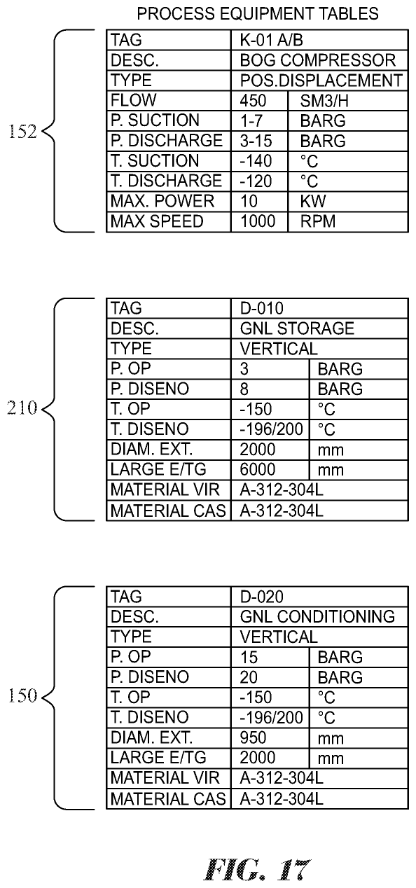

The present invention can be referred to as a liquefied natural gas (LNG) and compressed natural gas (CNG) storage, processing, and delivery system comprising a modular multi-fueling platform 100 and a liquefied natural gas (LNG) storage Isotank assembly 200, as illustrated in FIG. 1. Details of the micro turbine assembly modular multi-fueling platform 100 are presented in FIGS. 2 through 13. Schematics illustrating a high level conception of two variants of the present invention are presented in FIGS. 14 and 15. A detailed schematic is presented in FIGS. 16A through 16H, with additional support of the schematic presented in FIGS. 17 through 21.

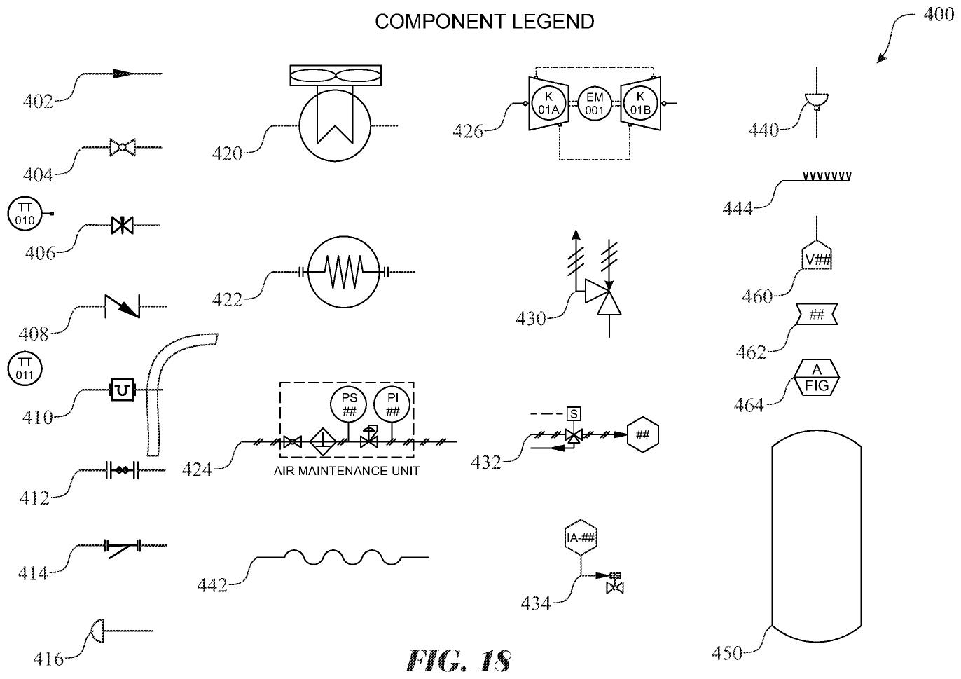

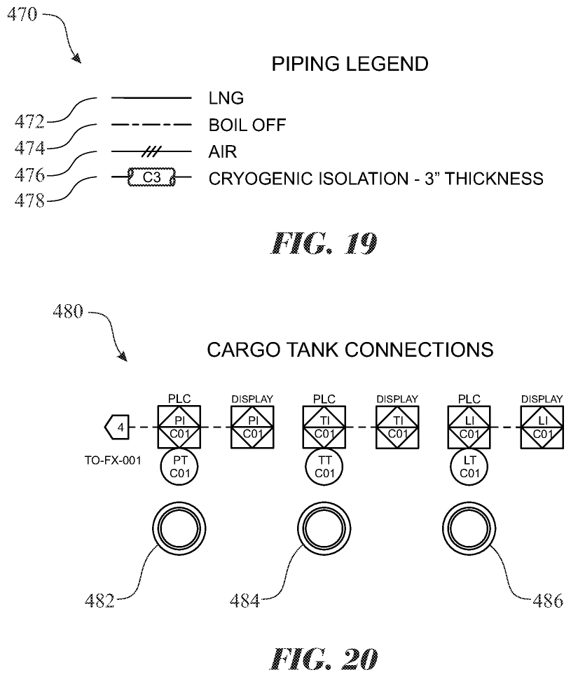

A component legend 400 for the components of the schematic is presented in FIG. 18, with a legend of the piping or process lines references 470 being presented in FIG. 19.

Direction of flow of the liquefied natural gas (LNG) in the schematic 16A through 16G is identified by a stream flow direction 402.

Major components included in the schematic include:
a vessel 450 (sometimes referred to as a tank or any other component for containment of a pressurized volume of a composition),
a compressor 426 (such as a boiling off gas compressor (BOC)),
an air cooler/heater 420 (commonly provided in a form of a heat exchanger and optionally including or utilizing an electric heater 422), and
an instrument air treatment unit (filter, lubrication and regulation) 424.

The schematic includes several types of valves. The following is a list of the types of valves included in the schematic presented in FIGS. 16A through 16G:
a manual valve 404,
a needle valve 406,
a check valve 408,
a break-away valve 412,
a safety valve 430,
a solenoid valve 432, and
an actuated on-off valve 434.

Additional support components illustrated in the schematic include:
a mass flow meter 410,
a filter “Y” 414,
a cap 416,
a drain connection 440,
a hose 442, and
a diffuser 444.

The schematic includes several functional or connection indicators or links. The following is a list of functional or connection indicators or links included in the schematic presented in FIGS. 16A through 16G:
an on page connector 460 provides a connection between each of a plurality of ventilation lines; more specifically, V01 through V12,
a stream code 462, which provides a reference to an index of operating condition, and
an off page connector 464 provides connectivity between pipe segments illustrated in two different figures. The off page connector 464 includes an identifying letter located in an upper section of the off page connector 464 and a FIG reference located in a lower section of the off page connector 464. The letter identifies a unique connection point. The FIG. reference provides an aid to locating the letter identifying the unique connection point.

The plumbing or piping arrangements of the schematic illustrated in FIGS. 16A through 16G are illustrated having four (4) distinct functions. Liquefied natural gas (LNG) is transferred via piping identified by a line style symbolizing a liquefied natural gas (LNG) line 472. Boil off gas (BOG) is transferred via piping identified by a line style symbolizing a boil off line 474. Air or gas is transferred via piping identified by a line style symbolizing an air line 476. The system is designed to maintain the liquefied natural gas (LNG) at a very cold temperature. To minimize thermal transfer and maintain the liquefied natural gas (LNG) at a very cold temperature, the respective piping transferring the liquefied natural gas (LNG) is preferably protected using cryogenic isolation. This piping is identified by a symbol representative of a cryogenic insulated line 478.

For completeness, a cargo tank signals and connectivity map 480 is presented in FIG. 21. The cargo tank signals and connectivity map 480 presents various signals that are obtained and presented from a vehicle tank (cargo tank) 250 (FIGS. 14 and 15). A liquefied natural gas (LNG) cargo tank connection 482 is provided for connectivity to the liquefied natural gas (LNG) filling line to a vehicle tank (cargo tank) 182. A vapor vent line cargo tank connection 484 is provided for connectivity to the vapor vent line from vehicle tank (cargo tank) 184. A liquefied natural gas (LNG) cargo tank connection 486 is provided for connectivity to the liquefied natural gas (LNG) filling line to the vehicle tank (cargo tank) 182 or a receiving line from the vehicle tank (cargo tank) 182.

In one exemplary design, the liquefied natural gas (LNG) and compressed natural gas (CNG) storage, processing, and delivery system the modular multi-fueling platform 100 can provide a capacity for loading vehicles of up to 1,100 liter capacity with liquid natural gas at different temperature conditions. The liquid temperature conditions can be selected by the recipient, where the liquid temperature conditions would be based upon the requirements of the receiving vehicle.

The modular multi-fueling platform 100 essentially comprises a storage tank 210; a heating or heat exchanging system 154, 155; a heater 157; a compressor 152; and a liquefied natural gas (LNG) conditioning tank 150. The heat exchanger 155 that employs the heater 157 is optional, where the combination of the heater 157 and the heat exchanger 155 would be included in conditions where the aero-heat exchanger 154 is not deemed to be sufficient. The size and number of heat exchangers 154, 155 would be dependent upon the specific application and installation environment. In the exemplary illustrations, the modular multi-fueling platform 100 and the liquefied natural gas (LNG) storage Isotank assembly 200 are shown as separate assemblies. The liquefied natural gas (LNG) storage Isotank assembly 200 can be provided by the customer or the supplier of the modular multi-fueling platform 100. For smaller systems, the liquefied natural gas (LNG) storage Isotank assembly 200 can be integrated into the modular multi-fueling platform 100.

The modular multi-fueling platform 100 includes a frame 111, which provides support structure directly or indirectly to each of the components of the modular multi-fueling platform 100. The components are protected by an enclosure 110. The enclosure 110 includes a front covering, a first side covering, a second side covering, a rear covering, an upper or top covering, and preferably, a base or bottom covering. A front panel 112 is an exemplary front covering. A first side covering can include a first side panel 120. In the exemplary illustrations, the first side covering is enhanced, including the first side panel 120 and a pair of first side doors 122. One or both first side door 122 of the pair of first side doors 122 can include at least one of a first side door handle 124 and a first side door vent 126. In the exemplary illustration each first side door 122 of the pair of first side doors 122 includes one first side door handle 124 and one first side door vent 126. The first side panel 120 can also include one or more first side door vents 126. Each first side door 122 can include one or more first side door vents 126 to provide adequate ventilation. Each first side door 122 of the pair of first side doors 122 can be hingeably assembled to the frame 111, the first side panel 120, or any other suitable component of the modular multi-fueling platform 100.

A second side covering can include a second side panel 130. The second side cover can mirror the first side covering, as illustrated, or provide asymmetrical covers, where the first side cover and the second side cover differ from one another. In the exemplary illustrations, the second side cover is enhanced, including the second side panel 130 and a pair of second side doors 132. One or both second side door 132 of the pair of second side doors 132 can include at least one of a second side door handle 134 and a second side door vent 136. In the exemplary illustration each second side door 132 of the pair of second side doors 132 includes one second side door handle 134 and one second side door vent 136. The second side panel 130 can also include one or more second side door vents 136. Each second side door 132 can include one or more second side door vents 136 to provide adequate ventilation. Each second side door 132 of the pair of second side doors 132 can be hingeably assembled to the frame 111, the second side panel 130, or any other suitable component of the modular multi-fueling platform 100.

A rear covering can include a rear panel 114. The rear panel 114 can optionally include one or more rear panel vents 115, as shown in the exemplary illustration. The rear panel 114 can be assembled to the first side panel 120, the second side panel 130 and/or the frame 111. Additionally, the rear panel 114 can be assembled to one or both of the roof panel 116 and a base 118. The base 118 can be integrated into the frame 111 or provided as a separate component that is removable from other components of the enclosure 110 and/or the frame 111.

Each of the components that collectively define the enclosure 110 can be removably assembled accordingly, enabling easy access to functional components of the modular multi-fueling platform 100 normally concealed by the enclosure 110. This can be accomplished by utilizing tongue and slot mechanical interfaces, snaps, magnetized elements and magnetically attracting elements, threaded fasteners (such as screws, bolts, cams, and the like), removable pins, or any other suitable releasable mechanical assembly.

The enclosure 110 can provide support for additional components and/or include openings, in addition to those previously described, for passage of components, ventilation, and the like. For example, the front panel 112 can include accesses to each of a liquefied natural gas (LNG) filling line to vehicle tank (cargo tank) 182 and a vapor vent line from vehicle tank 184. In another example, the roof panel 116 can include at least one roof airflow aperture 117, providing airflow to a heat exchanger 154. In yet another example, the roof panel 116 can include an aperture for passage of a vent pipe 159 therethrough.

At least one operational feedback device and at least one control component can be assembled to one or more components of the enclosure 110. In the exemplary illustrations, an exemplary operational feedback device is a display 142 assembled to the front panel 112 and a first user input component 144 and a second user input component 146 are examples of at least one control component; the first user input component 144 and the second user input component 146 being assembled to the front panel 112 at a location proximate the display 142. It is understood that the display 142, the first user input component 144, and the second user input component 146 can be installed at any suitable location providing easy access by an operator. It would also be advantageous to locate the display 142, the first user input component 144, and the second user input component 146 at a location proximate the liquefied natural gas (LNG) filling line to vehicle tank (cargo tank) 182 and the vapor vent line from vehicle tank 184. The display 142, the first user input component 144 and the second user input component 146 can be instrumental when transferring liquefied natural gas (LNG) to a vehicle tank using the liquefied natural gas (LNG) filling line to vehicle tank (cargo tank) 182 and controlling ventilation from the vehicle truck through the vapor vent line from vehicle tank 184.

The enclosure 110 can include access to ports enabling fluid communication between the LNG storage Isotank and the modular multi-fueling platform 100. In the exemplary illustrations, this includes a system vapor transfer line to between Isotank, conditioning tank and cargo tank 170, a system liquefied natural gas (LNG) transfer line between Isotank and cargo tank 172, and a system liquefied natural gas (LNG) transfer line between Isotank and conditioning tank 174. The system vapor transfer line to between Isotank, conditioning tank and cargo tank 170, the system liquefied natural gas (LNG) transfer line between Isotank and cargo tank 172, and the system liquefied natural gas (LNG) transfer line between Isotank and conditioning tank 174 can be assembled to the frame 111 or a component of the enclosure 110. Passageways would be formed in the respective component of the enclosure 110, providing access to the system vapor transfer line to between Isotank, conditioning tank and cargo tank 170, the system liquefied natural gas (LNG) transfer line between Isotank and cargo tank 172, and the system liquefied natural gas (LNG) transfer line between Isotank and conditioning tank 174.

The modular multi-fueling platform 100 is provided in fluid communication with the liquefied natural gas (LNG) storage Isotank assembly 200, as illustrated in FIG. 1. The liquefied natural gas (LNG) storage Isotank assembly 200 is preferably fabricated having an extremely efficient insulation provided between an inner wall and an outer wall. The liquefied natural gas (LNG) storage Isotank assembly 200 includes a liquefied natural gas (LNG) storage Isotank 210 comprising a liquefied natural gas (LNG) storage Isotank front end wall 214 assembled to a first end of a liquefied natural gas (LNG) storage Isotank cylindrical sidewall 212 and a liquefied natural gas (LNG) storage Isotank rear end wall 216 assembled to a second, opposite end of the liquefied natural gas (LNG) storage Isotank cylindrical sidewall 212. The liquefied natural gas (LNG) storage Isotank 210 is supported by a liquefied natural gas (LNG) storage Isotank support frame 220. The liquefied natural gas (LNG) storage Isotank support frame 220 includes a liquefied natural gas (LNG) storage Isotank support frame forward structure 224 assembled at a first end of a liquefied natural gas (LNG) storage Isotank support frame base 222 and a liquefied natural gas (LNG) storage Isotank support frame rearward structure 226 assembled at a second, opposite end of the liquefied natural gas (LNG) storage Isotank support frame base 222. The liquefied natural gas (LNG) storage Isotank cylindrical sidewall 212 is supported along an elongated length by the liquefied natural gas (LNG) storage Isotank support frame base 222. The liquefied natural gas (LNG) storage Isotank 210 is retained against rotation and/or lateral motion by at least one feature provided by the liquefied natural gas (LNG) storage Isotank support frame rearward structure 226. in the exemplary illustration, the liquefied natural gas (LNG) storage Isotank support frame rearward structure 226 includes a liquefied natural gas (LNG) storage Isotank support frame rearward structure circumferential flange 227, wherein the liquefied natural gas (LNG) storage Isotank rear end wall 216 is seated within the liquefied natural gas (LNG) storage Isotank support frame rearward structure circumferential flange 227. Brackets or other connecting members can be provided between the liquefied natural gas (LNG) storage Isotank support frame forward structure 224 and the liquefied natural gas (LNG) storage Isotank front end wall 214 to support the liquefied natural gas (LNG) storage Isotank 210 at the first end thereof.

Connectivity between the modular multi-fueling platform 100 and the liquefied natural gas (LNG) storage Isotank assembly 200 is provided by a series of hoses or other form of pluming. In the exemplary illustrations, a flexible connecting vapor transfer line to between Isotank, conditioning tank and cargo tank 171 provides fluid communication between the system vapor transfer line to between Isotank, conditioning tank and cargo tank 170 and a liquefied natural gas (LNG) storage Isotank—liquefied natural gas (LNG) transfer coupling 230; a flexible connecting liquefied natural gas (LNG) transfer line between Isotank and cargo tank 173 provides fluid communication between the system liquefied natural gas (LNG) transfer line between Isotank and cargo tank 172 and a liquefied natural gas (LNG) storage Isotank—vapor transfer coupling 232; and a flexible connecting liquefied natural gas (LNG) transfer line between Isotank and conditioning tank 175 provides fluid communication between the system liquefied natural gas (LNG) transfer line between Isotank and conditioning tank 174 and a liquefied natural gas (LNG) storage Isotank—liquefied natural gas (LNG) transfer coupling 236. The liquefied natural gas (LNG) storage Isotank assembly 200 can additionally include an optional liquefied natural gas (LNG) storage Isotank—liquefied natural gas (LNG) transfer coupling 234. Flow through the liquefied natural gas (LNG) storage Isotank—liquefied natural gas (LNG) transfer coupling 230 can be controlled by a liquefied natural gas (LNG) storage Isotank—liquefied natural gas (LNG) transfer valve 231. Flow through the liquefied natural gas (LNG) storage Isotank—vapor transfer coupling 232 can be controlled by a liquefied natural gas (LNG) storage Isotank—vapor transfer valve 233. Flow through the liquefied natural gas (LNG) storage Isotank—liquefied natural gas (LNG) transfer coupling 234 can be controlled by a liquefied natural gas (LNG) storage Isotank—liquefied natural gas (LNG) transfer valve 235. Flow through the liquefied natural gas (LNG) storage Isotank—liquefied natural gas (LNG) transfer coupling 236 can be controlled by a liquefied natural gas (LNG) storage Isotank—liquefied natural gas (LNG) transfer valve 237. Each of the valves 231, 233, 235, 237 can be manually operated, electronically operated, or automatically operated.

The modular multi-fueling platform 100 is illustrated in several drawings where the enclosure 110 is shown being removed. This provides views of the modular multi-fueling platform 100 to identify several key components thereof that are normally obscured by the enclosure 110 during operation. A heat exchanger 154 is located proximate an upper region of the modular multi-fueling platform 100, as placement of the heat exchanger 154 commonly considers heat transfer to the environment. In the exemplary illustration, the heat exchanger 154 is located proximate or at an upper region of the modular multi-fueling platform 100 and proximate the plurality of roof airflow apertures 117 passing through the roof panel 116.

A liquefied natural gas (LNG) conditioning tank 150 is contained within the frame 111, preferably at a central location of the frame 111. The modular multi-fueling platform 100 utilizes the liquefied natural gas (LNG) conditioning tank 150 to store liquefied natural gas (LNG) for conditioning.

Other components that are identified in the various illustrations exclusive of the enclosure 110 include an electric motor 158 and a boiling off gas compressor (BOC) 152. Other features identified include several fluid communication ports, including an inlet to compressor cylinder 1 190, an inlet to compressor cylinder 2 192, an outlet from compressor cylinder 1 194, and an outlet from compressor cylinder 2 196.

One general operating principle behind the modular multi-fueling platform 100 is presented in the schematic diagram presented in FIG. 14. A modified variant of the general operating principle behind the modular multi-fueling platform 100 is presented in the schematic diagram presented in FIG. 15.

The fundamental concept relies upon the ideal gas law, also referred to as the general gas equation, is an equation of state of a hypothetical ideal gas. It is a good approximation of the behavior of many gases under many conditions, although the ideal gas law has several limitations. The ideal gas law was first stated by Benoit Paul Emile Clapeyron in 1834 as a combination of the empirical Boyle's law, Charles's law, Avogadro's law, and Gay-Lussac's law. The ideal gas law is often written in an empirical form: P*V=n*R*T, where:
a. P=Pressure
b. V=Volume
c. T=Temperature
d. n=amount of the substance
e. R=ideal gas constant

The ideal gas law is directed towards an ideal gas. Most gases, such as air, natural gas, and the like, more accurately follow the Joule-Thomson effect.

Combining the laws of Charles, Boyle and Gay-Lussac gives the combined gas law, which takes the same functional form as the ideal gas law save that the number of moles is unspecified, and the ratio of P*V/T is simply considered as constant (k), where P*V/T=k where:
a. P=Pressure
b. V=Volume
c. T=Temperature
d. k=constant

This consideration then provides the following formula P1*V1/T1=P2*V2/T2, where:
a. P1=Pressure in 1^{st} condition
b. V1=Volume in 1^{st} condition
c. T1=Temperature in 1^{st} condition
d. P2=Pressure in 2^{nd} condition
e. V2=Volume in 2^{nd} condition
f. T2=Temperature in 2^{nd} condition

In addition to changes of the natural gas in a gaseous state, the system also involves changes between a gaseous state and a liquid state. When a substance goes from one state of matter—solid, liquid, or gas—to another state of matter, the process is a change of state. Some rather interesting things occur during this process. In a condition where a composition is changing from a gaseous state to a liquid state, the phase change is referred to as condensation.

The liquefied natural gas (LNG) and compressed natural gas (CNG) storage, processing, and delivery system in accordance with the present invention, the system (also referred to as a LNG/CNG system) will have the capacity to transfer Liquefied Natural Gas (LNG) from the liquefied natural gas (LNG) storage Isotank assembly 200 to a liquefied natural gas (LNG) conditioning tank 150, generating a pressure difference between the liquefied natural gas (LNG) storage Isotank assembly 200 and the liquefied natural gas (LNG) conditioning tank 150 using a boiling off gas compressor (BOC) 152. The boiling off gas compressor (BOC) 152 is driven by an electric motor 158 using a variable speed drive (not identified). Once the liquefied natural gas (LNG) conditioning tank 150 is filled, boiled off gas (BOG) will be re-circulated through the boiling off gas compressor (BOC) 152, forcing the boiled off gas (BOG) going through a heating system, until bringing the boiled off gas (BOG) to the desired temperature. The boiled off gas (BOG) will then be pressurized, taking boiled off gas (BOG) from storage and injecting it into the liquefied natural gas (LNG) conditioning tank 150, in order to transfer it to the vehicle tank (cargo tank) 250.

The LNG/CNG system is represented by the schematic illustrated in FIGS. 16A through 16G. Operation of the LNG/CNG system can be best understood by referencing differences between various characteristic states of the natural gas, as the states change based upon the respective function of the component. The range of each of a temperature, a pressure, a mass flow rate, and a % vapor phase are presented in the following table:

TABLE 1A
System Operating Parameters: Temperature & Pressure

| | | Temperature | | | Pressure | | |
|---|---|---|---|---|---|---|---|
| | | [° C.] | | | [Barg] | | |
| In- | | Con- | | | Con- | | |
| dicator | | stant | Raises | Lower | stant | Raises | Lower |
| Z1 | | N/A | | | | | |
| Z2 | 95 | 15 | 40 | −150 | 3 | 8 | 2 |
| Z3 | BOG | −130 | −100 | −150 | 3 | 8 | 2 |
| Z4 | GNL | −130 | −125 | −150 | 3 | 8 | 2 |
| Z5 | GNL | −130 | −125 | −150 | 3 | 8 | 2 |
| Z6 | | N/A | | | | | |
| Z7 | BOG | −130 | −100 | −150 | 3 | 8 | 2 |
| Z8 | BOG | −130 | −100 | −150 | 3 | 8 | 2 |
| Z9 | BOG | −130 | −100 | −150 | 3 | 8 | 2 |
| Z10 | BOG | −130 | −100 | −150 | 3 | 8 | 2 |
| Z11 | BOG | −130 | −100 | −150 | 3 | 8 | 2 |
| Z12 | BOG | −130 | −100 | −150 | 3 | 8 | 2 |
| Z13 | BOG AP | −130 | −80 | −150 | 3 | 20 | 2 |
| Z14 | BOG AP | −130 | −80 | −150 | 3 | 20 | 2 |
| Z15 | BOG MP | −130 | −80 | −150 | 3 | 16 | 2 |
| Z16 | BOG MP | −130 | −80 | −150 | 3 | 16 | 2 |
| Z17 | BOG MP | −130 | −80 | −150 | 3 | 16 | 2 |
| Z18 | BOG AP | −130 | −80 | −150 | 3 | 20 | 2 |
| Z20 | GNL | −130 | −125 | −150 | 3 | 8 | 2 |
| Z21 | GNL | −130 | −125 | −150 | 3 | 8 | 2 |
| Z22 | GNL AP | −130 | −125 | −150 | 3 | 16 | 2 |
| Z30 | | N/A | | | | | |
| Z31 | 95 | 15 | 40 | −150 | 3 | 8 | 2 |
| Z32 | BOG MP | −130 | −80 | −150 | 3 | 16 | 2 |
| Z33 | BOG MP | −130 | −80 | −150 | 3 | 16 | 2 |
| Z34 | BOG MP | −130 | −80 | −150 | 3 | 16 | 2 |
| Z35 | BOG MT | −130 | 30 | −150 | 3 | 16 | 2 |
| Z36 | BOG AT | −130 | 70 | −150 | 3 | 16 | 2 |
| Z40 | GNL | −130 | −125 | −150 | 3 | 8 | 2 |
| Z41 | GNL | −130 | −125 | −150 | 3 | 8 | 2 |
| Z42 | GNL | −130 | −125 | −150 | 3 | 8 | 2 |
| Z43 | BOG | −130 | −100 | −150 | 3 | 8 | 2 |
| Z44 | BOG | −130 | −100 | −150 | 3 | 8 | 2 |
| Z45 | BOG | −130 | −100 | −150 | 3 | 8 | 2 |
| Z50 | AIR | 15 | 40 | −10 | 8 | 10 | 5 |
| Z51 | AIR | 15 | 40 | −10 | 8 | 10 | 5 |
| Z52 | AIR | 15 | 40 | −10 | 8 | 10 | 5 |
| Z53 | VENT AIR | 15 | 40 | −10 | 0 | 0 | 0 |
| Z54 | AIR | 15 | 40 | −10 | 8 | 10 | 5 |
| Z55 | AIR | 15 | 40 | −10 | 8 | 10 | 5 |
| Z60 | GNL AP | −130 | −125 | −150 | 3 | 16 | 2 |
| Z61 | GNL AP | −130 | −125 | −150 | 3 | 16 | 2 |
| Z62 | GNL AP | −130 | −125 | −150 | 3 | 16 | 2 |
| Z63 | GNL AP | −130 | −125 | −150 | 3 | 16 | 2 |
| Z64 | GNL AP | −130 | −125 | −150 | 3 | 16 | 2 |
| Z65 | GNL AP | −130 | −125 | −150 | 3 | 16 | 2 |
| Z66 | GNL AP | −130 | −125 | −150 | 3 | 16 | 2 |
| Z67 | GNL AP | −130 | −125 | −150 | 3 | 16 | 2 |
| Z70 | BOG MP | −130 | −80 | −150 | 3 | 16 | 2 |
| Z71 | BOG MP | −130 | −80 | −150 | 3 | 16 | 2 |
| Z72 | BOG MP | −130 | −80 | −150 | 3 | 16 | 2 |
| Z73 | BOG | −130 | −100 | −150 | 3 | 8 | 2 |
| Z74 | BOG | −130 | −100 | −150 | 3 | 8 | 2 |
| Z75 | BOG | −130 | −100 | −150 | 3 | 8 | 2 |
| Z80 | VENT GAS | 15 | 40 | −100 | 0 | 0.5 | 0 |
| Z81 | VENT GAS | 15 | 40 | −100 | 0 | 0.5 | 0 |
| Z82 | VENT GAS | 15 | 40 | −100 | 0 | 0.5 | 0 |
| Z83 | DRENAJE | 15 | 40 | −10 | 0 | 0 | 0 |

TABLE 1B
System Operating Parameters: Mass Flow Rate & % Vapor Phase

| | | Mass Flow Rate | | | % Vapor Phase | | |
|---|---|---|---|---|---|---|---|
| | | [Kg/h] | | | % | | |
| In- | | Con- | | | Con- | | |
| dicator | | stant | Raises | Lower | stant | Raises | Lower |
| Z1 | | N/A | | | | | |
| Z2 | 95 | 0 | 50 | 0 | 100 | 100 | 0 |
| Z3 | BOG | 0 | 300 | 0 | 100 | 100 | 100 |
| Z4 | GNL | 0 | 20000 | 0 | 0 | 0 | 0 |
| Z5 | GNL | 0 | 20000 | 0 | 0 | 0 | 0 |
| Z6 | | N/A | | | | | |
| Z7 | BOG | 0 | 300 | 0 | 100 | 100 | 100 |
| Z8 | BOG | 0 | 300 | 0 | 100 | 100 | 100 |
| Z9 | BOG | 0 | 300 | 0 | 100 | 100 | 100 |
| Z10 | BOG | 0 | 300 | 0 | 100 | 100 | 100 |
| Z11 | BOG | 0 | 300 | 0 | 100 | 100 | 100 |
| Z12 | BOG | 0 | 300 | 0 | 100 | 100 | 100 |
| Z13 | BOG AP | 0 | 300 | 0 | 100 | 100 | 100 |
| Z14 | BOG AP | 0 | 300 | 0 | 100 | 100 | 100 |
| Z15 | BOG MP | 0 | 300 | 0 | 100 | 100 | 100 |
| Z16 | BOG MP | 0 | 300 | 0 | 100 | 100 | 100 |
| Z17 | BOG MP | 0 | 300 | 0 | 100 | 100 | 100 |
| Z18 | BOG AP | 0 | 300 | 0 | 100 | 100 | 100 |
| Z20 | GNL | 0 | 20000 | 0 | 0 | 0 | 0 |
| Z21 | GNL | 0 | 20000 | 0 | 0 | 0 | 0 |
| Z22 | GNL AP | 0 | 20000 | 0 | 0 | 0 | 0 |
| Z30 | | N/A | | | | | |
| Z31 | 95 | 0 | 50 | 0 | 100 | 100 | 0 |
| Z32 | BOG MP | 0 | 300 | 0 | 100 | 100 | 100 |
| Z33 | BOG MP | 0 | 300 | 0 | 100 | 100 | 100 |
| Z34 | BOG MP | 0 | 300 | 0 | 100 | 100 | 100 |
| Z35 | BOG MT | 0 | 300 | 0 | 100 | 100 | 100 |
| Z36 | BOG AT | 0 | 300 | 0 | 100 | 100 | 100 |
| Z40 | GNL | 0 | 20000 | 0 | 0 | 0 | 0 |
| Z41 | GNL | 0 | 20000 | 0 | 0 | 0 | 0 |
| Z42 | GNL | 0 | 20000 | 0 | 0 | 0 | 0 |
| Z43 | BOG | 0 | 300 | 0 | 100 | 100 | 100 |
| Z44 | BOG | 0 | 300 | 0 | 100 | 100 | 100 |
| Z45 | BOG | 0 | 300 | 0 | 100 | 100 | 100 |
| Z50 | AIR | 0 | 0.05 | 0 | 100 | 100 | 100 |
| Z51 | AIR | 0 | 0.05 | 0 | 100 | 100 | 100 |
| Z52 | AIR | 0 | 0.05 | 0 | 100 | 100 | 100 |
| Z53 | VENT AIR | 0 | 0.05 | 0 | 100 | 100 | 100 |
| Z54 | AIR | 0 | 0.05 | 0 | 100 | 100 | 100 |
| Z55 | AIR | 0 | 0.05 | 0 | 100 | 100 | 100 |
| Z60 | GNL AP | 0 | 20000 | 0 | 0 | 0 | 0 |
| Z61 | GNL AP | 0 | 20000 | 0 | 0 | 0 | 0 |
| Z62 | GNL AP | 0 | 20000 | 0 | 0 | 0 | 0 |
| Z63 | GNL AP | 0 | 20000 | 0 | 0 | 0 | 0 |
| Z64 | GNL AP | 0 | 20000 | 0 | 0 | 0 | 0 |
| Z65 | GNL AP | 0 | 20000 | 0 | 0 | 0 | 0 |
| Z66 | GNL AP | 0 | 20000 | 0 | 0 | 0 | 0 |
| Z67 | GNL AP | 0 | 20000 | 0 | 0 | 0 | 0 |
| Z70 | BOG MP | 0 | 300 | 0 | 100 | 100 | 100 |
| Z71 | BOG MP | 0 | 300 | 0 | 100 | 100 | 100 |
| Z72 | BOG MP | 0 | 300 | 0 | 100 | 100 | 100 |
| Z73 | BOG | 0 | 300 | 0 | 100 | 100 | 100 |
| Z74 | BOG | 0 | 300 | 0 | 100 | 100 | 100 |
| Z75 | BOG | 0 | 300 | 0 | 100 | 100 | 100 |
| Z80 | VENT GAS | 0 | 2000 | 0 | 100 | 100 | 100 |
| Z81 | VENT GAS | 0 | 2000 | 0 | 100 | 100 | 100 |
| Z82 | VENT GAS | 0 | 2000 | 0 | 100 | 100 | 100 |
| Z83 | DRENAJE | 0 | 5 | 0 | 0 | 0 | 0 |

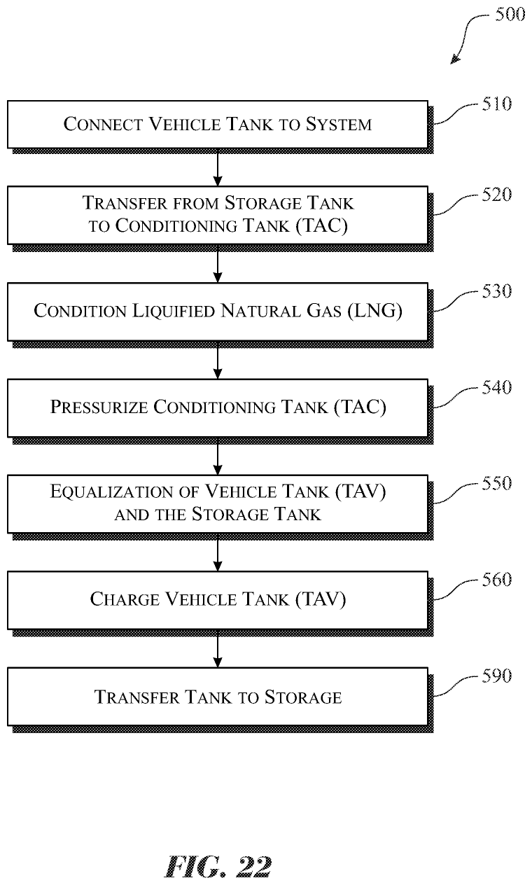

In this way, the main processes of a operational process overview flow diagram 500, presented in FIG. 22, are defined as follows:
a) A vehicle tank (TAC) to system connection process 510;
b) A storage tank to conditioning tank (TAC) transfer process 520;
c) A liquefied natural gas (LNG) conditioning process 530;
d) A conditioning tank (TAC) pressurizing process 540;
e) A vehicle tank (TAC) and storage tank equalization process 550;
f) A vehicle tank (TAV) charging process 560; and
g) A supply tank to storage tank process 590.

The modular multi-fueling platform 100 is a transfer element that is connected to a liquefied natural gas (LNG) storage Isotank 210 in FIG. 1. Liquefied natural gas (LNG) accumulates in the liquefied natural gas (LNG) storage Isotank 210. The modular multi-fueling platform 100 has several functions as explained herein. The first function is that the modular multi-fueling platform 100 helps another truck transporting a vehicle tank (cargo tank)(TAV) 250 to come and unload the liquefied natural gas (LNG) and put the liquefied natural gas (LNG) inside the liquefied natural gas (LNG) storage Isotank 210. The modular multi-fueling platform 100 provides a solution. The modular multi-fueling platform 100 transmits the liquefied natural gas (LNG) flow to and from the liquefied natural gas (LNG) storage Isotank 210. In a condition where the modular multi-fueling platform 100 is arranged to load the liquefied natural gas (LNG) into a vehicle tank (TAV) 250, the modular multi-fueling platform 100 draws a quantity of the liquefied natural gas (LNG) and put the quantity of the liquefied natural gas (LNG) into the 150, wherein the liquefied natural gas (LNG) conditioning tank 150 is contained within the modular multi-fueling platform 100. The modular multi-fueling platform 100 draws the liquefied natural gas (LNG) from of the liquefied natural gas (LNG) storage Isotank 210 in FIG. 1 and transfers the liquefied natural gas (LNG) to the liquefied natural gas (LNG) conditioning tank 150 utilizing a pressure differential between the liquefied natural gas (LNG) storage Isotank 210 and the liquefied natural gas (LNG) conditioning tank 150. The liquefied natural gas (LNG) collected within the liquefied natural gas (LNG) conditioning tank 150 is then conditioned by adjusting a pressure and temperature of the stored liquefied natural gas (LNG) accordingly as required for each type of vehicle. Once the stored liquefied natural gas (LNG) is at the pressure and temperature established by the receiving vehicle tank (TAV) 250, the liquefied natural gas (LNG) stored in the liquefied natural gas (LNG) conditioning tank 150 is then pressurized to transport the liquefied natural gas (LNG) through the liquefied natural gas (LNG) filling line to vehicle tank 182 to the vehicle tank (TAV) 250.

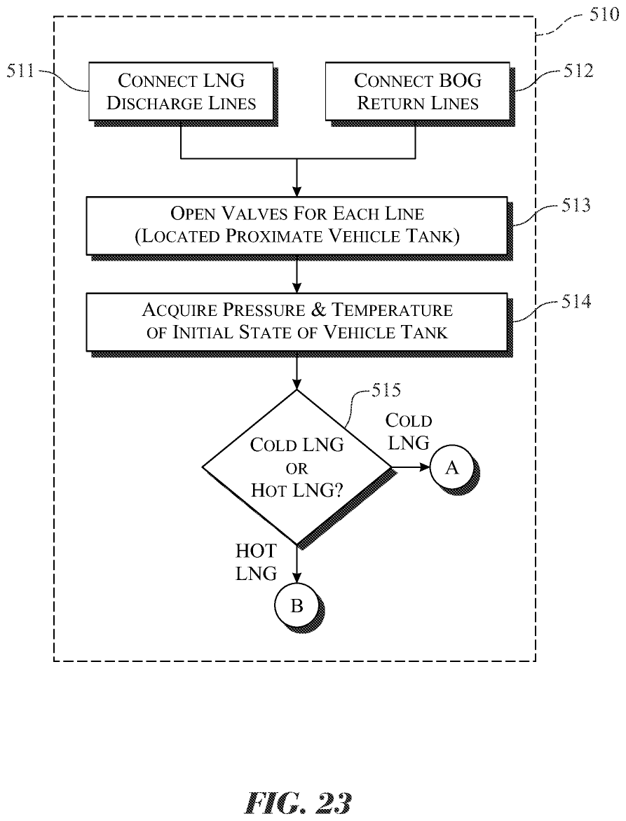

Details of the vehicle tank (TAC) to system connection process 510 are presented in FIG. 23. In accordance with the vehicle tank (TAC) to system connection process 510:

The vehicle tank (TAC) to system connection process 510 starts with a loading process. The process is initiated when a connection between the cargo tank 250 of a vehicle and the LNG/CNG system is made. The Liquefied Natural Gas (LNG) discharge lines 182 are connected (step 511) and the boil off gas (BOG) return lines 184 of the vehicle tank (cargo tank) 250 are also connected (step 512). The respective valves (generally manual valves) for each line will be opened (step 513). The respective valves are commonly located at the rear of the vehicle tank (cargo tank) 250. Pressure and temperature transmitters located on the boil off gas (BOG) line 184 will transmit the initial state of the liquefied natural gas (LNG) storage Isotank assembly 200 to be loaded. The system acquires the pressure and temperature of the initial state of the vehicle tank (step 514).

Depending on the type of vehicle, the client must select two required conditions of Liquefied Natural Gas (LNG) and then start the loading process:
Cold or “Not Saturated” Liquefied Natural Gas (LNG): Pressure less than 6 barg (Temperature −160 to −134° C.)
Hot Liquefied Natural Gas (LNG): Pressure 6 to 10 barg (Temperature −134 to −123° C.)

The condition of the Liquefied Natural Gas (LNG) is selected in accordance with a decision step 515.

This selection will define the subsequent equalization and charging processes of the vehicle tank (cargo tank) 250. The operator would provide the associated information via the first user input component 144 and the second user input component 146 of the modular multi-fueling platform 100. Details of the schematic that are associated with the connection process are provided in the portion of the schematic presented in FIG. 16F. Flow of the liquefied natural gas (LNG) to the vehicle tank (cargo tank) 250 is provided through the liquefied natural gas (LNG) filling line to vehicle tank (cargo tank) 182. Flow of the boiling off gas (BOG) from the vehicle tank (cargo tank) 250 is provided through the vapor vent line from vehicle tank (cargo tank) 184.

Not all vehicles utilize the same charging temperature and pressure. A first exemplary truck comprising a configuration of the vehicle tank (TAV) 250 having certain requirements for loading the vehicle tank (TAV) 250. Other exemplary trucks have other requirements for loading the vehicle tank (TAV) 250. Depending on which truck configuration is being loaded, the truck provides instructions for a desired loading temperature and pressure. The process stops at different points depending on which configuration of the vehicle tank (TAV) 250 is being loaded. It is pure logic. The process starts by heating the liquefied natural gas (LNG) from −150 F.° and you go up in pressure and temperature until the pressure and temperature reach the temperature and pressure required by the configuration of the vehicle tank (TAV) 250 of the truck. For example, of the temperature and pressure required by the configuration of the vehicle tank (TAV) 250 of the truck is −130 F.° and 8 Bar, then the process stops when the liquefied natural gas (LNG) reaches −130 F.° and 8 Bar. In a second example, the temperature required by the configuration of the vehicle tank (TAV) 250 of the truck would be −130 F°, then the system 100 would continue heating the liquefied natural gas (LNG) a little more until the liquefied natural gas (LNG) reaches 130 F°.

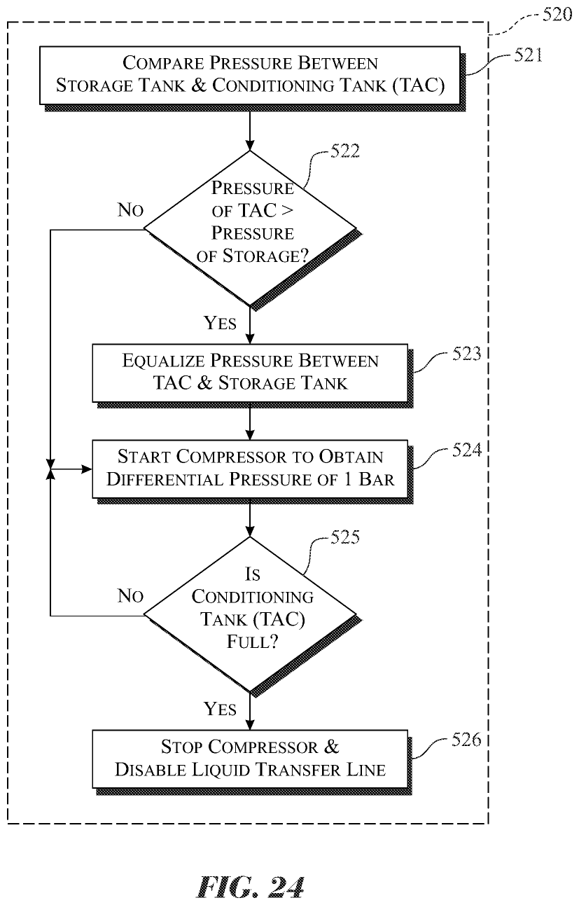

Details of the storage tank to conditioning tank (TAC) transfer process 520 are presented in FIG. 24. In accordance with the process of transferring Liquefied Natural Gas (LNG) from the liquefied natural gas (LNG) storage Isotank 210 to the vehicle tank (cargo tank) 250 (process 520):

The process of transferring 520 Liquefied Natural Gas (LNG) from the liquefied natural gas (LNG) storage Isotank 210 to the vehicle tank (cargo tank) 250 is accomplished by generating a pressure difference between the liquefied natural gas (LNG) storage Isotank 210 and the liquefied natural gas (LNG) conditioning tank 150 through the boiling off gas compressor (BOC) 152. The process begins by comparing the pressure measurements of both tanks 150, 210 (step 521). The process acquires a pressure of the liquefied natural gas (LNG) storage Isotank 210 and the liquefied natural gas (LNG) conditioning tank 150. Pressure of the liquefied natural gas (LNG) conditioning tank 150 and pressure of the liquefied natural gas (LNG) storage Isotank 210 are compared with one another (decision step 522). If the pressure of the liquefied natural gas (LNG) conditioning tank 150 is greater than the pressure of the liquefied natural gas (LNG) storage Isotank 210, the pressure differential must be equalized. The pressure differential is equalized (step 523) by opening valves XV-100 and XV-200 in FIG. 16A.

In a condition where the pressure of the liquefied natural gas (LNG) conditioning tank 150 is greater than the pressure of the liquefied natural gas (LNG) storage Isotank 210, the process equalizes pressure between the liquefied natural gas (LNG) conditioning tank 150 and the liquefied natural gas (LNG) storage Isotank 210 (step 523). Valves XV-100, XV-200, XV-601 are cryogenic valves which are opened to achieve equalization between the liquefied natural gas (LNG) conditioning tank 150 and the liquefied natural gas (LNG) storage Isotank 210 (step 523). If the pressure of the liquefied natural gas (LNG) conditioning tank 150 and the pressure of the liquefied natural gas (LNG) storage Isotank 210, are already equalized (as determined in decision step 522), the process proceeds to step 524.

Once equalized, the boiling off gas compressor (BOC) 152 is activated to generate a pressure differential of 1 bar (step 524). The pressure differential of 1 bar creates a condition that will enable the transfer line of liquid. The boiling off gas compressor (BOC) 152 will maintain a differential pressure of 1 bar throughout the process, until the transferred mass measurement indicates that the liquefied natural gas (LNG) conditioning tank 150 load is complete. The state of the liquefied natural gas (LNG) conditioning tank 150 load is monitored during a condition tank (TAC) load status decision step 525. In a condition where the liquefied natural gas (LNG) conditioning tank 150 is not full, the boiling off gas compressor (BOC) 152 continues to function, maintaining the differential pressure of 1 Bar (step 524).

In this condition, the compressor stops and the liquid transfer line is disabled (step 526). The process is completed using portions of the schematic presented in FIGS. 16A, 16B, and 16C.

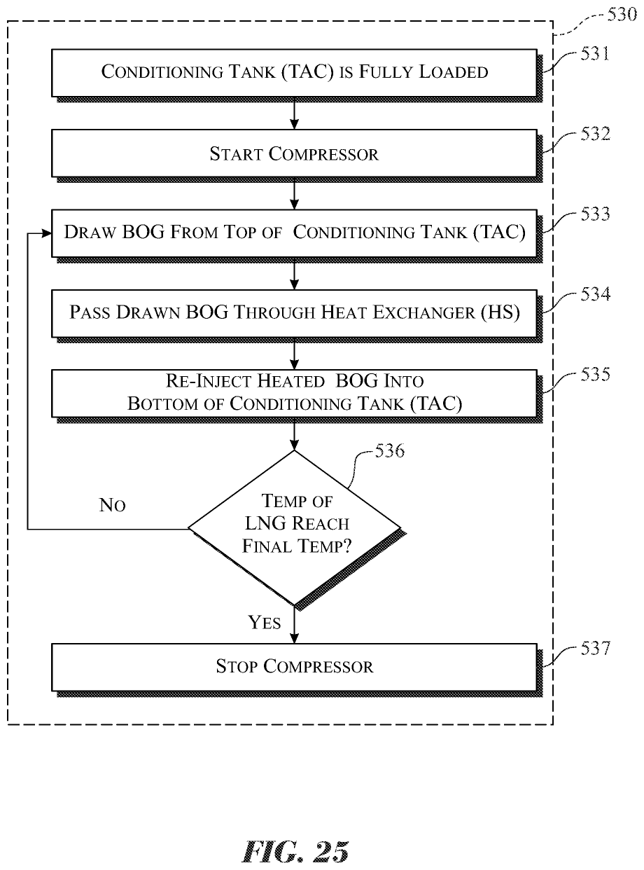

The liquefied natural gas (LNG) conditioning process 530 is detailed in FIG. 25. Steps to complete the process of conditioning the transferring Liquefied Natural Gas (LNG) 530 are as follows:

The execution of this process, or not, will depend on the type of vehicle to be loaded and the selection that has been taken by the client at point 3 (hot or cold liquefied natural gas (LNG)).

The step of conditioning the transferring Liquefied Natural Gas (LNG) initiates with the liquefied natural gas (LNG) conditioning tank 150 loaded (state 531) with liquefied natural gas (LNG) in the conditions that remained after the transfer. The boiling off gas compressor (BOC) 152 is started (step 532). The boiling off gas compressor (BOC) 152 will take boil off gas (BOG) from the top of the liquefied natural gas (LNG) conditioning tank 150 (step 533), and pass the boil off gas (BOG) through the heating system 154, 155, 156 (step 534), then re-inject the processed boil off gas (BOG) into the bottom of the liquefied natural gas (LNG) conditioning tank 150 (step 535). Valve XV-101 is opened and closing valve XV-201 is closed while the boiling off gas compressor (BOC) 152 takes boil off gas (BOG) from the top of the liquefied natural gas (LNG) conditioning tank 150 (step 533). Valve XV-800 is opened and all other valves are closed while re-injecting the processed boil off gas (BOG) into the bottom of the liquefied natural gas (LNG) conditioning tank 150 (step 535). This will form a closed circuit that will subject the liquefied natural gas (LNG) to heat until it reaches the final temperature, indicated by the temperature transmitters located on the liquefied natural gas (LNG) conditioning tank 150. The temperature of the liquefied natural gas (LNG) is measured. The acquired temperature of the liquefied natural gas (LNG) is reviewed to determine if the acquired temperature of the liquefied natural gas (LNG) is at a final temperature (decision step 536). In a condition where the acquired temperature of the liquefied natural gas (LNG) has not yet reached the final temperature (decision step 536), the process continues with the steps of boiling off gas compressor (BOC) 152 will take boil off gas (BOG) from the top of the liquefied natural gas (LNG) conditioning tank 150 (step 533), passing the boil off gas (BOG) through the heating system 154, 155, 156 (step 534), then re-injecting the processed boil off gas (BOG) into the bottom of the liquefied natural gas (LNG) conditioning tank 150 (step 535). In a condition where the acquired temperature of the liquefied natural gas (LNG) reaches the final temperature (decision step 536), the compressor is stopped (step 537).

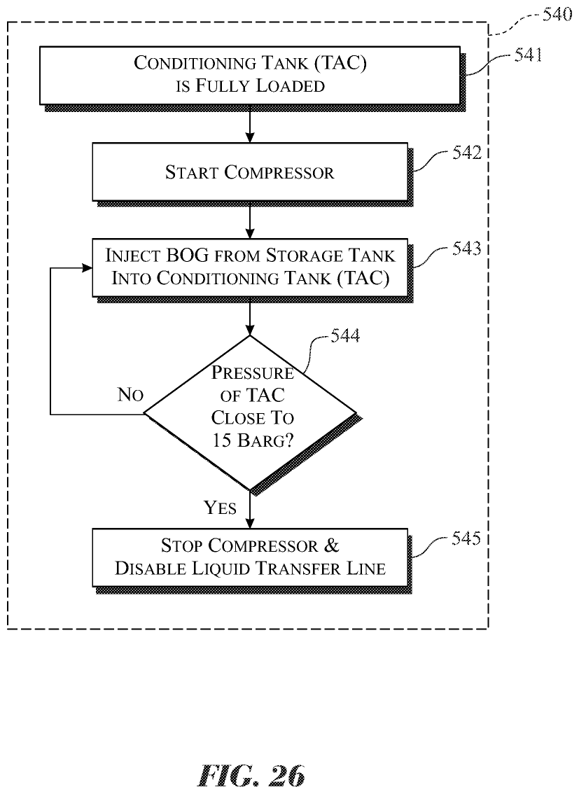

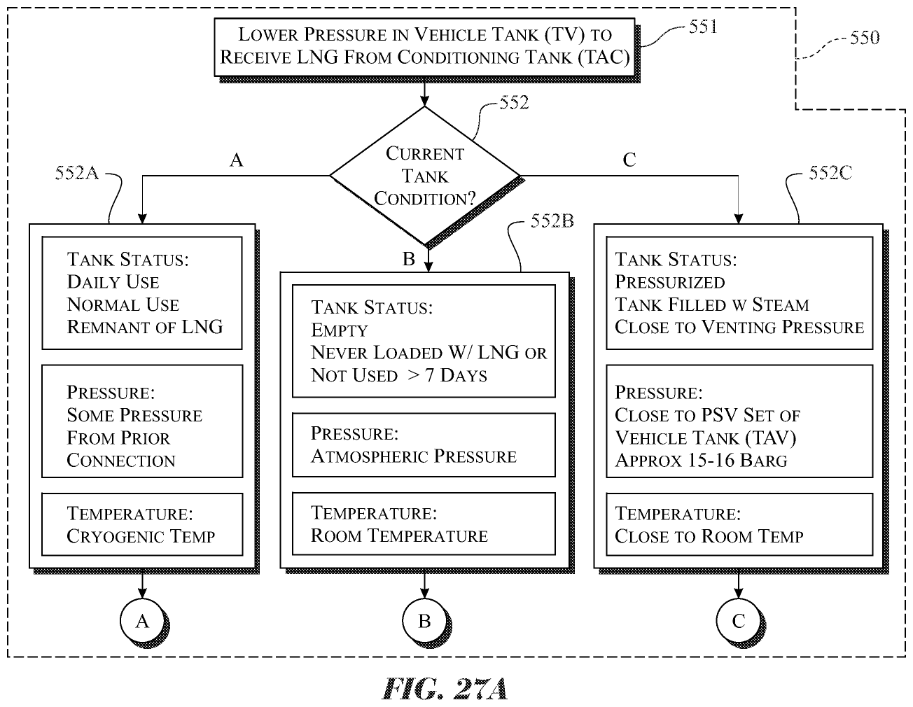

Details of steps associated with the process of pressurizing the liquefied natural gas (LNG) conditioning tank 150 (process 540) are presented in FIG. 26.

Steps of the process of pressurizing the liquefied natural gas (LNG) conditioning tank 150 (process 540) are as follows:

The process of pressurizing the liquefied natural gas (LNG) conditioning tank 150 consists of bringing the liquefied natural gas (LNG) conditioning tank 150 to an adequate pressure to enable unloading of the liquefied natural gas (LNG) to the vehicle tank (cargo tank) 250. The process of pressurizing the liquefied natural gas (LNG) conditioning tank 150 initiates with the liquefied natural gas (LNG) conditioning tank 150 being loaded (status 541). The boiling off gas compressor (BOC) 152 activates (step 542), taking boil off gas (BOG) from storage, and injecting the boil off gas (BOG) into the liquefied natural gas (LNG) conditioning tank 150 (step 543). Valves XV-100 and XV-201 are opened and valves XV-101 and XV-200 as well as all other valves are closed during the injection of the boil off gas (BOG) it into the liquefied natural gas (LNG) conditioning tank 150 (step 543). The process continues until a pressure close to 15 barg is reached. The pressure of the liquefied natural gas (LNG) conditioning tank 150 is monitored to determine if the pressure within the liquefied natural gas (LNG) conditioning tank 150 is close to or at 15 Barg (decision step 544). In a condition where the pressure within the liquefied natural gas (LNG) conditioning tank 150 has not reached 15 Barg, the process of taking boil off gas (BOG) from storage, and injecting the boil off gas (BOG) it into the liquefied natural gas (LNG) conditioning tank 150 (step 543) continues.

In a condition where the pressure inside the liquefied natural gas (LNG) conditioning tank 150 reaches a pressure of 15 barg, the process will stop the boiling off gas compressor (BOC) 152 and isolate the liquefied natural gas (LNG) conditioning tank 150. In this condition, the liquefied natural gas (LNG) stored within the liquefied natural gas (LNG) conditioning tank 150 is considered to be filled and ready for the transfer to the vehicle tank (cargo tank) 250 (status 541).

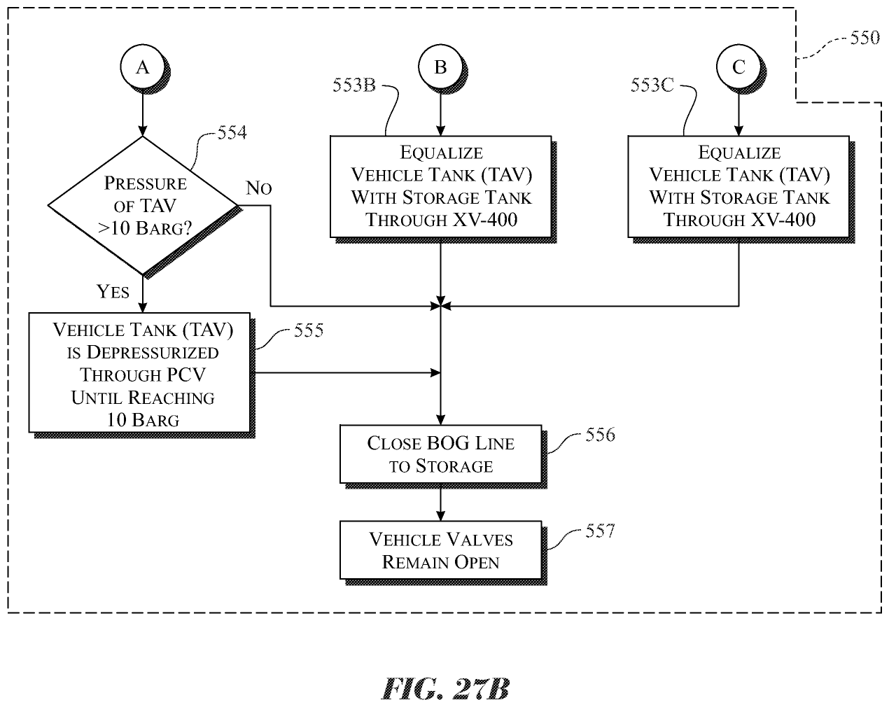

Details of steps associated with the process of vehicle tank (TAC) and storage tank equalization process (process 550) are presented in FIGS. 27A and 27B. Steps of vehicle tank (TAC) and storage tank equalization process (process 550) are as follows:

The process of equalizing pressure between the vehicle tank (cargo tank) 250 and the liquefied natural gas (LNG) storage Isotank 210 (process 550) consists of lowering the pressure of the vehicle tank (cargo tank) 250 to be able to transfer liquefied natural gas (LNG) from the liquefied natural gas (LNG) conditioning tank 150 (already pressurized) (step 551). Pressure and temperature transmitters located on the boil off gas (BOG) line or vapor vent line from vehicle tank 184 will transmit the initial state of the tank to be loaded. Here the system must define three (3) different situations and respective different actions to take for each case: Condition A: Tank in Daily Use 552A; Condition B: Empty Tank 552B; and Condition C: Pressurized Tank 552C. Details of each condition are presented in FIG. 27A and in table 1, presented below.

TABLE 1

| | Tank in Daily Use | Empty Tank | Pressurized Tank |
|---|---|---|---|
| | (Condition A) | (Condition B) | (Condition C) |
| Descrip- | In normal use. | Was never loaded | Tank filled |
| tion | Liquefied Natural | with Liquefied | with steam at |
| | Gas (LNG) remnant. | Natural Gas | Temperature |
| | | (LNG) or was | close to Room |
| | | unloaded | Temperature. |
| | | completely and | Standing for |
| | | it was not used | a considerable |
| | | for at least 7 | time, reaching |
| | | days. | Pressure close |
| | | | to the Venting |
| | | | Pressure. |
| Pressure | Pressure resulting | Atmospheric | Pressure close |
| Condition | from the conditions | Pressure | to that of |
| | in which it has | | the PSV set |
| | been loaded before | | of Cargo Tank |
| | and its use prior | | (Vehicle Tank). |
| | to connection. | | Expected between |
| | | | 15 and16 Barg. |
| Temper- | Cryogenic | Room | Temperature |
| ature | Temperature | Temperature | close to Room |
| Condition | | | Temperature |

In the loading process several equalization steps are required, depending on the initial conditions mentioned in Table 1 above. The process would determine a current condition of the vehicle tank (cargo tank) 250 (decision step 552), which is based upon determination of the characteristics of the tank respective to the conditions presented in Table 1 above to classify the vehicle tank (cargo tank) 250 as being one of the first considered vehicle tank (TV) condition (normal use) 552A, the second considered vehicle tank (TV) condition (empty tank) 552B, or the third considered vehicle tank (TV) condition (pressurized tank) 552C. In a condition where the vehicle tank (cargo tank) 250 is classified as a first considered vehicle tank (TV) condition (normal use) 552A, the process proceeds to determine if the pressure within the vehicle tank (cargo tank) 250 is greater than 10 Barg (decision step 554). In a condition where the pressure of the vehicle tank (cargo tank) 250 is greater than 10 Barg, the vehicle tank (cargo tank) 250 is depressurized through the PCV until the pressure within the vehicle tank (cargo tank) 250 reaches 10 Barg (step 555) and the process proceeds to step 556. In a condition where the pressure of the vehicle tank (cargo tank) 250 is less than 10 Barg, the process proceeds directly to step 556.

In a condition where the vehicle tank (cargo tank) 250 is classified as a second considered vehicle tank (TV) condition (empty tank) 552B, or a third considered vehicle tank (TV) condition (pressurized tank) 552C, the process proceeds to a step of equalizing the vehicle tank (cargo tank) 250 with the liquefied natural gas (LNG) storage Isotank 210 (steps 553B, 553C respectively), whereby the equalization is accomplished through valve XV-400. Once the vehicle tank (cargo tank) 250 is equalized (completion of steps 553B, 553C respectively), the process proceeds to step 556.

Upon reaching a desired pressure within the vehicle tank (cargo tank) 250 (as described above), the valve controlling flow between from vapor vent line from vehicle tank 184 to the liquefied natural gas (LNG) storage Isotank 210 will be closed (step 556); but the manual valve included in the vehicle tank (cargo tank) 250 will remain open (notation 557).

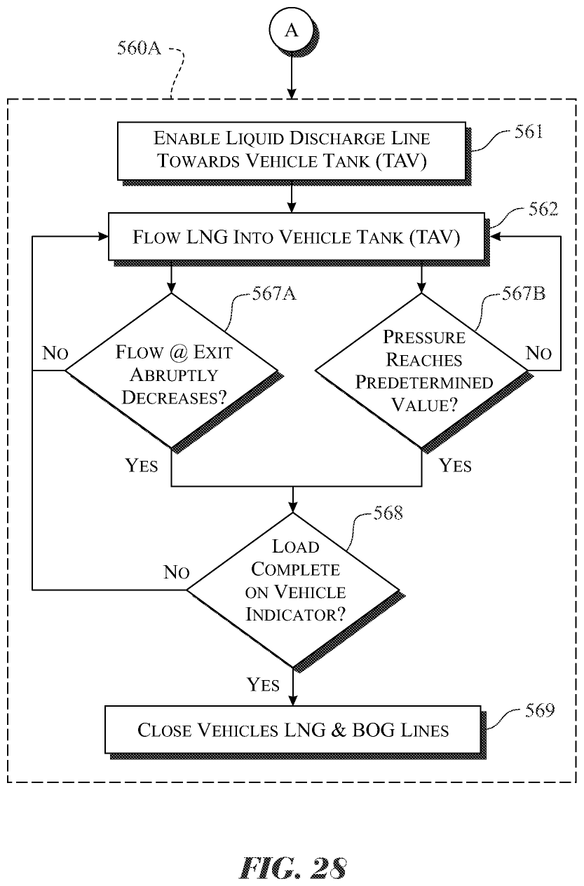

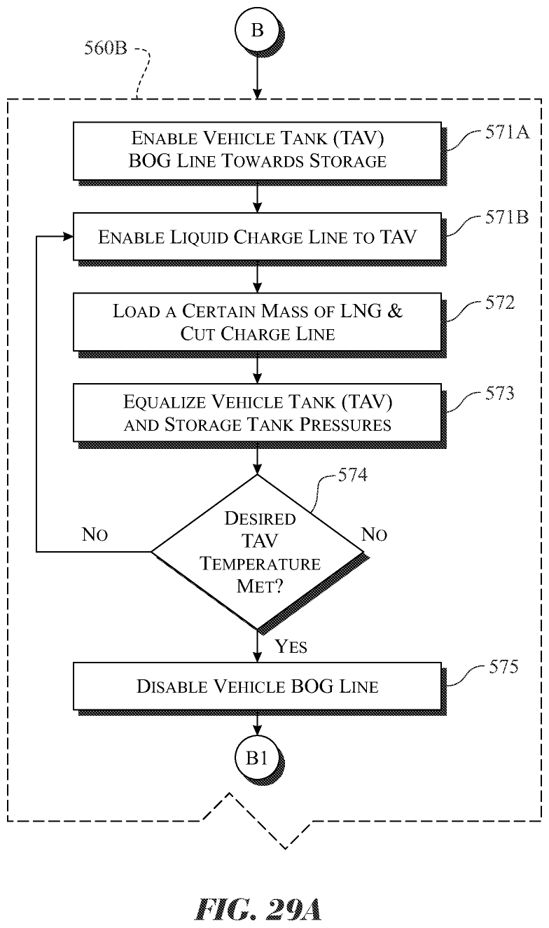

Details of steps associated with the process of charging the vehicle tank (TAV) 250 (process 560) are presented in FIG. 28. Steps of charging the vehicle tank (TAV) 250 process (process 560) are as follows:

The process of loading of liquefied natural gas (LNG) to the vehicle tank (cargo tank) 250 is accomplished by utilizing a pressure difference between liquid between the liquefied natural gas (LNG) conditioning tank 150 (already pressurized) and the vehicle tank (cargo tank) 250. The process will automatically terminate when the pressure in the discharge line 184 increases sharply or when the transfer flow decreases sharply.

As in the case of the vehicle tank (cargo tank) 250 equalization, this transfer process will depend on the initial pressure and temperature conditions of the vehicle tank (cargo tank) 250. Therefore, the system can define three (3) different processes: a vehicle tank (TAV) charging process (first set of tank conditions—normal use) 560A; a vehicle tank (TAV) charging process (second set of tank conditions—empty tank) 560B; and a vehicle tank (TAV) charging process (third set of tank conditions—pressurized tank) 560C.

Details associated with the cargo tank or vehicle tank (TAV) charging process (first set of tank conditions—normal use) (process 560A) are presented in the flow diagram illustrated in FIG. 28. Upon determining that the vehicle tank (cargo tank) (TAV) 250 is considered to be normal use as defined by characteristics of the first considered vehicle tank (TAV) condition (normal use) 552A above, the process proceeds with a step of enabling the liquid discharge line to flow liquefied natural gas (LNG) towards the vehicle tank (cargo tank) 250 (step 561). Once enabled, the liquefied natural gas (LNG) flows into the vehicle tank (cargo tank) 250 (step 562). Throughout the fill step 562, the process 560A proceeds with monitoring flow at the exit to determine when the flow at the exit abruptly decreases (step 567A). An abrupt decrease may be considered to be a drop to 10% in flow from the original value. Throughout the fill step 562, the process 560A also proceeds with monitoring the pressure within the vehicle tank (cargo tank) 250 to determine when the pressure within the vehicle tank (cargo tank) 250 reaches a predetermined value (step 567B). The predetermined value is established by the specific vehicle tank (cargo tank) 250 receiving the liquefied natural gas (LNG). Each of steps 567A and 567B are used as indicators that the vehicle tank (cargo tank) 250 is approaching or at a filled condition.

In a condition where the flow at the exit does not decrease abruptly (decision step 567A), the process continues flowing liquefied natural gas (LNG) flows into the vehicle tank (cargo tank) 250 (step 562).

In a condition where the pressure within the vehicle tank (cargo tank) 250 remains below the predetermined value (decision step 567B), the process continues flowing liquefied natural gas (LNG) flows into the vehicle tank (cargo tank) 250 (step 562).

In a condition where the flow at the exit abruptly decreases (decision step 567A), the process proceeds to decision step 568 (described below).

In a condition where the pressure within the vehicle tank (cargo tank) 250 reaches a predetermined value (decision step 567B), the process proceeds to decision step 568 (described below).

Once each decision step 567A, 567B determines the flow at the exit abruptly decreases (decision step 567A) and the pressure within the vehicle tank (cargo tank) 250 reaches a predetermined value (decision step 567B), the process 560A proceed with an inquiry to determine if the load indicator is indicating that the vehicle tank (cargo tank) 250 is complete (full) (decision step 568).

In a condition where the load indicator indicates that the vehicle tank (cargo tank) 250 is not yet complete (not yet full) (decision step 568), the process continues flowing liquefied natural gas (LNG) flows into the vehicle tank (cargo tank) (TAV) 250 (step 562).

In a condition where the load indicator indicates that the vehicle tank (cargo tank) (TAV) 250 is complete (full) (decision step 568), the process proceeds in closing the liquefied natural gas (LNG) and the boil off gas (BOG) lines of the vehicle tank (cargo tank) (TAV) 250 (step 569).

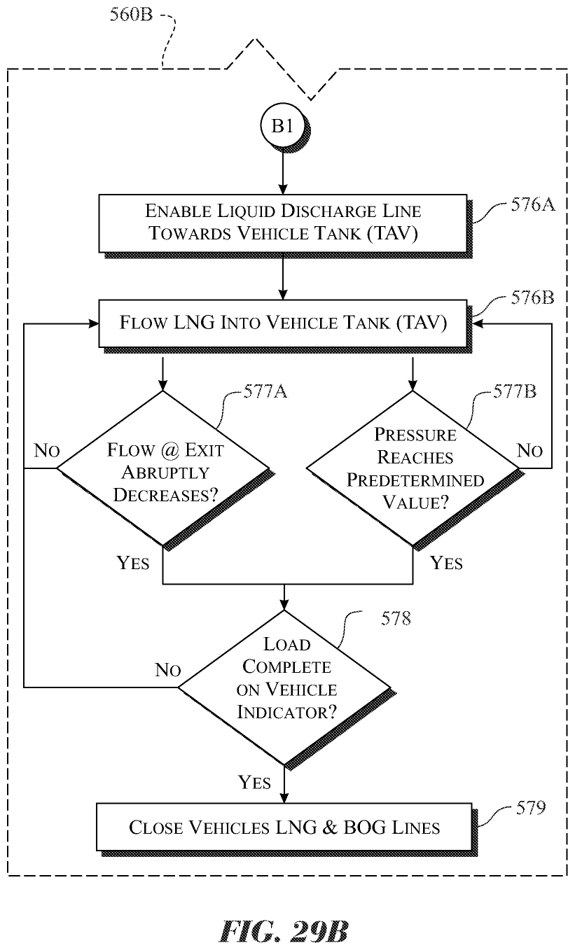

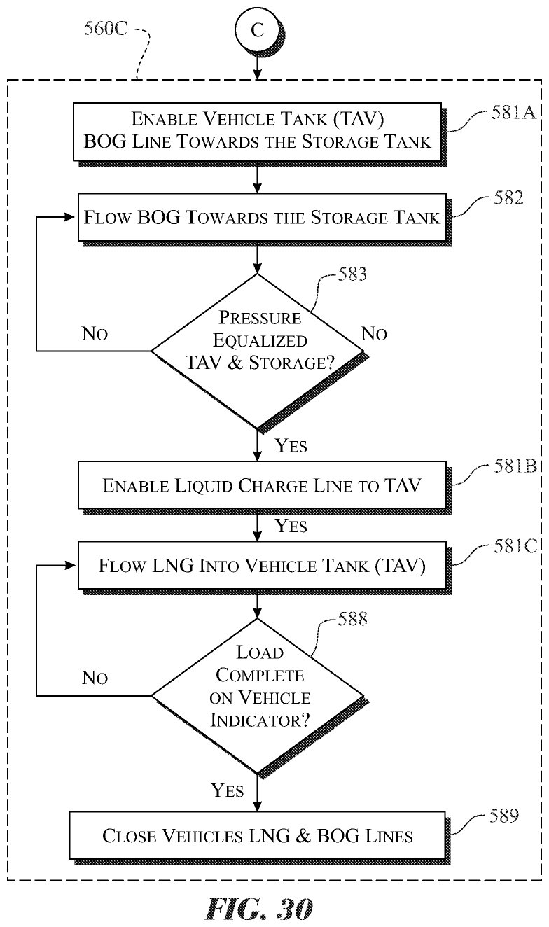

Details associated with the vehicle tank (TAV) charging process (second set of tank conditions—empty tank) (process 560B) are presented in the flow diagram illustrated in FIGS. 29A and 29B. The exemplary steps are presented in a segmented flow diagram illustrated in FIGS. 29A and 29B where a first portion of flow diagram 560B is presented in FIG. 29A and a second portion of flow diagram 560B is presented in FIG. 29B, with link B1 used to connect the first portion of flow diagram 560B and the second portion of flow diagram 560B.

Upon determining that the vehicle tank (TAV) is considered to be empty as defined by characteristics of the second considered vehicle tank (TV) condition (empty tank) 552B above, the process proceeds with a step of enabling the boil off gas (BOG) line to flow liquefied natural gas (LNG) towards the liquefied natural gas (LNG) storage Isotank 210 (step 571A) and a step of enabling the liquid charge line to flow liquefied natural gas (LNG) towards the vehicle tank (cargo tank) (TAV) 250 (step 571B). Valve XV-300 is opened while the liquid charge line is enabled to flow liquefied natural gas (LNG) towards the vehicle tank (cargo tank) (TAV) 250 (step 571B). Once enabled, the process 560B loads a certain mass of liquefied natural gas (LNG) into the vehicle tank (cargo tank) (TAV) 250 and cuts (closes) the charge line (step 572). The process continues with a step of equalizing the pressure within the vehicle tank (cargo tank) (TAV) 250 and the pressure within the liquefied natural gas (LNG) storage Isotank 210 (step 573). A loading valve XV-300 towards the vehicle is opened to load a certain mass of liquefied natural gas (LNG) for a short period of time, then valve XV-400 is opened to equalize the pressure within the vehicle tank (cargo tank) (TAV) 250 and the pressure within the liquefied natural gas (LNG) storage Isotank 210 (step 573). Once the pressure is equalized, the temperature of the vehicle tank (cargo tank) (TAV) 250 is acquired. The temperature is compared to a desired temperature of the vehicle tank (cargo tank) (TAV) 250 to determine if the temperature of the vehicle tank (cargo tank) (TAV) 250 is at the desired temperature of the vehicle tank (cargo tank) (TAV) 250.

In a condition where the temperature of the vehicle tank (cargo tank) (TAV) 250 is not at the desired temperature of the vehicle tank (cargo tank) (TAV) 250, the process returns to the step of enabling the liquid charge line to flow liquefied natural gas (LNG) towards the vehicle tank (cargo tank) (TAV) 250 (step 571B).

In a condition where the temperature of the vehicle tank (cargo tank) (TAV) 250 meets the desired temperature of the vehicle tank (cargo tank) (TAV) 250, the process proceeds by disabling the vehicle tank (cargo tank) (TAV) 250 boil off gas (BOG) line (step 575). The vehicle tank (cargo tank) (TAV) 250 liquid discharge line is enabled (step 576A). At this point, the process 560B continues replicating decision step 567A (identified as decision step 577A), decision step 567B (identified as decision step 567A), decision step 568 (identified as decision step 578), and terminating at step 569 (identified as step 579). In a condition where decision step 577A or decision step 577B are determined to be “no”, the process returns to the step of enabling the vehicle tank (cargo tank) (TAV) 250 liquid discharge line (step 576B).

In more detail, once the vehicle tank (cargo tank) (TAV) 250 liquid discharge line is enabled (step 576A), the liquefied natural gas (LNG) flows into the vehicle tank (cargo tank) (TAV) 250 (step 576B). Throughout the fill step 576B, the process 560B proceeds with monitoring flow at the exit to determine when the flow at the exit abruptly decreases (step 577A). Throughout the fill step 576B, the process 560B also proceeds with monitoring the pressure within the vehicle tank (cargo tank) (TAV) 250 to determine when the pressure within the vehicle tank (cargo tank) (TAV) 250 reaches a predetermined value (step 577B). Each of steps 577A and 577B are used as indicators that the vehicle tank (cargo tank) (TAV) 250 is approaching or at a filled condition.

In a condition where the flow at the exit does not decrease abruptly (decision step 577A), the process continues flowing liquefied natural gas (LNG) flows into the vehicle tank (cargo tank) (TAV) 250 (step 576B).

In a condition where the pressure within the vehicle tank (cargo tank) (TAV) 250 remains below the predetermined value (decision step 577B), the process continues flowing liquefied natural gas (LNG) flows into the vehicle tank (cargo tank) (TAV) 250 (step 576B).

In a condition where the flow at the exit abruptly decreases (decision step 577A), the process proceeds to decision step 578 (described below).

In a condition where the pressure within the vehicle tank (cargo tank) (TAV) 250 reaches a predetermined value (decision step 577B), the process proceeds to decision step 578 (described below).

Once each decision step 577A, 577B determines the flow at the exit abruptly decreases (decision step 577A) and the pressure within the vehicle tank (cargo tank) (TAV) 250 reaches a predetermined value (decision step 577B), the process 560B proceed with an inquiry to determine if the load indicator is indicating that the vehicle tank (cargo tank) (TAV) 250 is complete (full) (decision step 578).

In a condition where the load indicator indicates that the vehicle tank (cargo tank) (TAV) 250 is not yet complete (not yet full) (decision step 578), the process continues flowing liquefied natural gas (LNG) flows into the vehicle tank (cargo tank) (TAV) 250 (step 576B).

In a condition where the load indicator indicates that the vehicle tank (cargo tank) (TAV) 250 is complete (full) (decision step 578), the process proceeds in closing the liquefied natural gas (LNG) and the boil off gas (BOG) lines of the vehicle tank (cargo tank) (TAV) 250 (step 579).

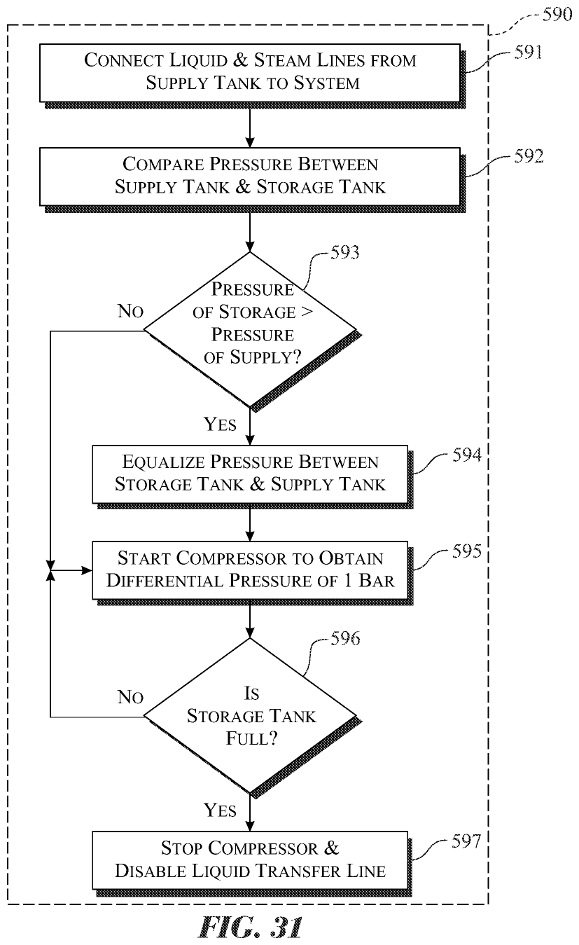

Details associated with the vehicle tank (TAV) charging process (third set of tank conditions—pressurized tank) (process 560C) are presented in the flow diagram illustrated in FIG. 30.

Upon determining that the vehicle tank (TAV) is considered to be a pressurized tank as defined by characteristics of the third considered vehicle tank (TV) condition (pressurized tank) 552C above, the process proceeds with a step of enabling the boil off gas (BOG) line to flow liquefied natural gas (LNG) towards the liquefied natural gas (LNG) storage Isotank 210 (step 581). Once enabled, the boil off gas (BOG) flows towards the liquefied natural gas (LNG) storage Isotank 210 (step 582). The pressure of the vehicle tank (cargo tank) (TAV) 250 and the pressure of the liquefied natural gas (LNG) storage Isotank 210 are acquired. The pressure of the vehicle tank (cargo tank) (TAV) 250 and the pressure of the liquefied natural gas (LNG) storage Isotank 210 are compared to one another to determine if the pressure is equalized (decision step 583).

In a condition where the pressure of the vehicle tank (cargo tank) (TAV) 250 and the pressure of the liquefied natural gas (LNG) storage Isotank 210 differ, the process continues to flow the boil off gas (BOG) towards the liquefied natural gas (LNG) storage Isotank 210 (step 582).

In a condition where the pressure of the vehicle tank (cargo tank) (TAV) 250 and the pressure of the liquefied natural gas (LNG) storage Isotank 210 have equalized, the process enables the liquid charge line towards the vehicle tank (cargo tank) (TAV) 250 (step 581B).

During flow of liquefied natural gas (LNG) towards the vehicle tank (cargo tank) (TAV) 250, the process repeats inquiries to determine if the load indicator is indicating that the vehicle tank (cargo tank) (TAV) 250 is complete (full) (decision step 588).

In a condition where the load indicator indicates that the vehicle tank (cargo tank) (TAV) 250 is not yet complete (not yet full) (decision step 588), the process continues flowing liquefied natural gas (LNG) flows into the vehicle tank (cargo tank) (TAV) 250 (step 581C).

In a condition where the load indicator indicates that the vehicle tank (cargo tank) (TAV) 250 is complete (full) (decision step 588), the process proceeds in closing the liquefied natural gas (LNG) and the boil off gas (BOG) lines of the vehicle tank (cargo tank) (TAV) 250 (step 589).

The following is a reference table associated with the vehicle tank (TAV) charging process 560:

Reference Table. Mass in Kg to be loaded in each step

| | |
|---|---|
| Cold LNG | Hot LNG |

| Loop | Small | Big | Small | Big |
|---|---|---|---|---|
| No | Tank | Tank | Tank | Tank |
| 1 | 2 | 5 | 2 | 5 |
| 2 | 5 | 10 | 2 | 5 |
| 3 | 7 | 20 | 5 | 10 |
| 4 | 20 | 50 | 5 | 10 |
| 5 | 50 | — | 7 | 20 |
| 6 | — | — | 20 | 50 |
| 7 | — | — | 50 | — |

After the loading of the vehicle tank (cargo tank) (TAV) 250 is complete, the valves of the vehicle's Liquefied Natural Gas (LNG) 182 and boil off gas (BOG) lines 184 are closed, allowing disconnection.

Details of steps associated with the process of transferring material from the supply tank to the liquefied natural gas (LNG) storage Isotank 210 (process 590) are presented in FIG. 31.

Steps of the process of transferring material from the supply tank to the liquefied natural gas (LNG) storage Isotank 210 (process 590) are as follows:

The liquefied natural gas (LNG) and the steam (boil off gas (BOG)) lines from the supply tank are connected to the modular multi-fueling platform 100 (step 591). A pressure of the supply tank and a pressure of the liquefied natural gas (LNG) storage Isotank 210 are acquired (step 592). The pressure of the supply tank and the pressure of the liquefied natural gas (LNG) storage Isotank 210 are compared with one another to determine if the pressure of the liquefied natural gas (LNG) storage Isotank 210 is greater than the pressure of the supply tank (decision step 593).

In a condition where the pressure of the liquefied natural gas (LNG) storage Isotank 210 is greater than the pressure of the supply tank (decision step 593), pressure between the liquefied natural gas (LNG) storage Isotank 210 and the supply tank are equalized (step 594). Once the pressure is equalized in accordance with a completion of step 594 or in a condition where the pressure of the liquefied natural gas (LNG) storage Isotank 210 is not greater than the pressure of the supply tank (decision step 593), the boiling off gas compressor (BOC) 152 is started to obtain a differential pressure between the storage tank and the supply tank of 1 Bar (step 595). A status of the liquefied natural gas (LNG) storage Isotank 210 is monitored to determine if the liquefied natural gas (LNG) storage Isotank 210 is full (decision step 596).

In a condition where the liquefied natural gas (LNG) storage Isotank 210 is not yet considered to be full (decision step 596), the compressor continues to maintain a pressure differential of 1 Bar (step 595).

In a condition where the liquefied natural gas (LNG) storage Isotank 210 is considered to be full (decision step 596), the compressor is stopped and the liquefied natural gas line is disabled (step 597).

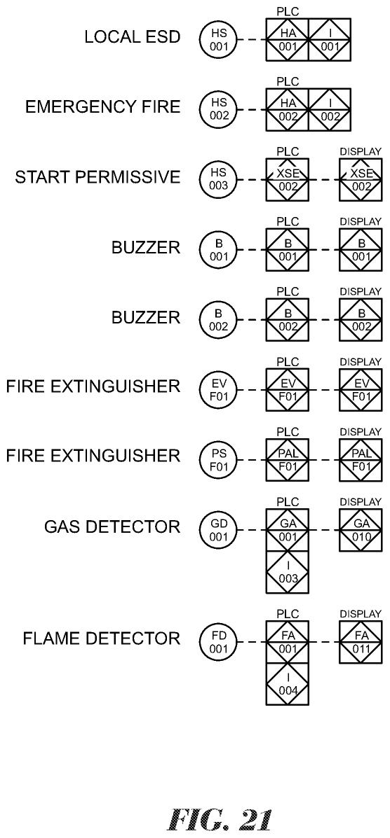

The step of recharging the liquefied natural gas (LNG) storage Isotank 210 from a vehicle tank (cargo tank) (TAV) 250 refills or recharges the liquefied natural gas (LNG) storage Isotank 210 from a delivery truck containing a vehicle tank (cargo tank) (TAV) 250. The step of recharging the liquefied natural gas (LNG) storage Isotank 210 from the vehicle tank (cargo tank) (TAV) 250 begins with the connection of the cistern to LNG/CNG system 100. A liquid line 182 and a steam line 184 are connected between the vehicle tank (cargo tank) 250 and the modular multi-fueling platform 100. The system receives signals from the pressure transmitter PT-001, temperature transmitter TT-001 and level transmitter LT-001 (FIG. 20).

The Programmable Logic Controller (PLC) 140 will compare the pressures of each of the liquefied natural gas (LNG) storage Isotank 210 and the vehicle tank (cargo tank) (TAV) 250. If a pressure within the liquefied natural gas (LNG) storage Isotank 210 is higher than a pressure within the cistern or vehicle tank (cargo tank) (TAV) 250, the pressure between the liquefied natural gas (LNG) storage Isotank 210 and the vehicle tank (cargo tank) (TAV) 250 must be equalized. Once the pressure between the liquefied natural gas (LNG) storage Isotank 210 and the vehicle tank (cargo tank) (TAV) 250 equalized, the system will initiate the boiling off gas compressor (BOC) 152 until generating a 1 bar pressure differential between the vehicle tank (cargo tank) (TAV) 250 and the liquefied natural gas (LNG) storage Isotank 210, a condition that will enable passage of the liquefied natural gas (LNG) through the liquid transfer line 182. The boiling off gas compressor (BOC) 152 will be responsible for maintaining a pressure differential of 1 bar throughout the process, until the transferred mass measurement indicates that the charging or refilling of the liquefied natural gas (LNG) storage Isotank 210 is completed.

In this condition the boiling off gas compressor (BOC) 152 will stop and the transfer of liquefied natural gas (LNG) through the liquid transfer line 182 is disabled. Subsequently, it remains only to return the cistern or vehicle tank (cargo tank) (TAV) 250 to its initial pressure. For this step, the steam line 184 will enable a pressure equalization of the vehicle tank (cargo tank) (TAV) 250 when compared with the pressure of the liquefied natural gas (LNG) storage Isotank 210 and with that of the liquefied natural gas (LNG) conditioning tank 150. To accomplish this, the vehicle tank (cargo tank) (TAV) 250 will be connected to either the liquefied natural gas (LNG) storage Isotank 210 or the liquefied natural gas (LNG) conditioning tank 150, which ever tank under the least pressure. If this procedure is unable to lower the pressure within the vehicle tank (cargo tank) (TAV) 250 to the required value, a compressed natural gas (CNG) to liquefied natural gas (LNG) compressor 153 will start until the required value is reached.

FIG. 15 represents two different stages, first the boiling off gas compressor (BOC) 152 compresses on the vertical conditioning tank 150, and in a second stage the compressed natural gas (CNG) to liquefied natural gas (LNG) compressor 153 depressurizes the volume from the liquefied natural gas (LNG) conditioning tank 150 and sends the volume to the liquefied natural gas (LNG) storage Isotank 210 via a liquefied natural gas (LNG) to storage tank transfer line 186. The modular multi-fueling platform 100 can be arranged to employ a single compressor 152, 153 to accomplish both functions. In a first process, the compressor 152 makes a transfer by generating a pressure differential between the liquefied natural gas (LNG) storage Isotank 210 and the liquefied natural gas (LNG) conditioning tank 150 so that the liquefied natural gas (LNG) flows from the liquefied natural gas (LNG) storage Isotank 210 to the liquefied natural gas (LNG) conditioning tank 150. Then, in a second process, the boiling off gas compressor (BOC) 152 circulates the gas within the liquefied natural gas (LNG) conditioning tank 150 for a period of time. Once a pressure within the liquefied natural gas (LNG) conditioning tank 150 reaches a certain pressure, the process loads the vehicle tank (cargo tank) (TAV) 250. Once the vehicle tank (cargo tank) (TAV) 250 is finished loading, the excess pressure is returned to the liquefied natural gas (LNG) conditioning tank 150 by the boiling off gas compressor (BOC) 152. The piping and valve arrangement could be configured to employ one compressor 152, 153 for the functions of each of the boiling off gas compressor (BOC) 152 and the compressed natural gas (CNG) to liquefied natural gas (LNG) compressor 153.

Operation of the LNG/CNG system can include several control loops. The following outlines each of the main control loops:

Main Control Loop a: Control loop for transferring from the liquefied natural gas (LNG) storage Isotank 210 to the liquefied natural gas (LNG) conditioning tank 150:

To start the transfer, the system must compare the pressures provided by pressure indication PI-010 (associated with the liquefied natural gas (LNG) storage Isotank 210) and PI-020 (associated with the liquefied natural gas (LNG) conditioning tank 150). If the pressure within the liquefied natural gas (LNG) conditioning tank 150 is higher than the pressure within the liquefied natural gas (LNG) storage Isotank 210, the pressures should be equalized first by opening valves XV-100 and XV-101, until the pressure indications PI-010, PI-020 are the same. When the pressure within the liquefied natural gas (LNG) conditioning tank 150 is less than or equal to the pressure within the liquefied natural gas (LNG) storage Isotank 210, valve XV-100 will be closed, valve XV-200 will be opened and the boiling off gas compressor (BOC) 152 will begin to generate a pressure differential of 1 bar. When a pressure differential between the liquefied natural gas (LNG) conditioning tank 150 and the liquefied natural gas (LNG) storage Isotank 210 reaches 1 bar, valve XV-700 will open allowing the transfer of liquefied natural gas (LNG) from the liquefied natural gas (LNG) storage Isotank 210 and the liquefied natural gas (LNG) conditioning tank 150.

The programmable logic controller (PLC) 140 will compare the pressure provided from the pressure indicator PI-010 and the pressure indicator PI-020 constantly and will adjust the speed of the boiling off gas compressor (BOC) 152, in order to maintain that differential value.

Similarly, at the beginning of the transfer process, the level indications of each of the liquefied natural gas (LNG) storage Isotank 210 and the liquefied natural gas (LNG) conditioning tank 150 must maintain consistent. (These indications will be calculated by the programmable logic controller (PLC) 140 according to the values provided by weight transmitters WT-021, WT-022 and WT-023 for the liquefied natural gas (LNG) conditioning tank 150 and WT-011, WT-012 and WT-013 for the liquefied natural gas (LNG) storage Isotank 210. Each of the weight transmitters are preferably located on the supports of each container, the liquefied natural gas (LNG) conditioning tank 150 and the liquefied natural gas (LNG) storage Isotank 210.

This transfer process will stop when the level in the liquefied natural gas (LNG) conditioning tank 150 reaches its maximum or when the level of the liquefied natural gas (LNG) storage Isotank 210 reaches its minimum. At this point, the boiling off gas compressor (BOC) 152 will stop and all the associated valves will be closed.

Main Control Loop b: Control loop for liquefied natural gas (LNG) conditioning:

The process of liquefied natural gas (LNG) conditioning will only be executed in a case that the recipient of the liquefied natural gas (LNG) has selected “hot liquefied natural gas (LNG)” during the process of configuring the load. If the recipient does not select “hot liquefied natural gas (LNG)” during the process of configuring the load, the system will proceed directly to a pressurization process.

The conditioning process will include a step of re-circulating boil off gas (BOG) through the liquefied natural gas (LNG) conditioning tank 150, directing the boil off gas (BOG) to pass through an intermediate heating system 154, 155, 156 that will provide enough heat to raise the temperature of the liquefied natural gas (LNG) at approximately −134° C. (This value will be adjusted according to the tests done in the field).

The process begins by verifying the temperature of the liquefied natural gas (LNG) conditioning tank 150 through measurements obtained by a TT-020 transmitter and a TT-021 transmitter. If the temperature is below −134° C., valve XV-101 and valve XV-800 will open, the boiling off gas compressor (BOC) 152 will start and the heating system 154, 155, 156 will be energized (EM-800 and HR-800 or HR-801). This heating system will consist of a forced air exchanger (AC-800) 154, 155 and a heater with electric coils (HE-800) 156 connected in series on the conditioning line. The forced air exchanger (AC-800) 154, 155 will include an automatic bypass to remove the forced air exchanger (AC-800) 154, 155 from service without completely disabling the entire heating system 154, 155, 156. This is because, under certain conditions, the surface of the forced air exchanger (AC-800) 154, 155 can be covered with ice from the room humidity and stop exchanging heat. In this scenario, a bypass will be opened through valve XV-801, being the only one heater the heater with electric coils (HE-800) 156 until the forced air exchanger (AC-800) 154, 155 thaws. The heater 156 (HE-800) is optional, where the heat exchangers can utilize ambient air as a heat source. The boiling off gas compressor (BOC) 152 will rotate at the highest speed possible, until the TT-020 transmitter and the TT-021 transmitter indicate that the temperature on the liquefied natural gas (LNG) conditioning tank 150 is −134° C. Once this temperature value is reached, the boiling off gas compressor (BOC) 152 will stop, the heating system 154, 155, 156 will be energized (EM-800 and HR-800 or HR-801) will be de-energized and the valve XV-101 and valve XV-800 will be closed again; being suitable for later pressurization.

Main Control Loop c: Control loop for pressurization of the liquefied natural gas (LNG) conditioning tank 150:

During the process of pressurizing the liquefied natural gas (LNG) conditioning tank 150, the pressure within the liquefied natural gas (LNG) conditioning tank 150 will rise in order to transfer liquefied natural gas (LNG) to the vehicle tank (cargo tank) (TAV) 250. The process of pressurizing the liquefied natural gas (LNG) conditioning tank 150 begins by monitoring the pressure in the liquefied natural gas (LNG) conditioning tank 150 through a pressure transmitter PT-020. If the value of the pressure is less than 15 barg, valves XV-100 and XV-201 will open and the boiling off gas compressor (BOC) 152 will start. Vapor will begin to be injected from the liquefied natural gas (LNG) storage Isotank 210 into the liquefied natural gas (LNG) conditioning tank 150. When the pressure in liquefied natural gas (LNG) conditioning tank 150 reaches 15 barg, the transfer to the vehicle tank (cargo tank) (TAV) 250 will begin. This process must maintain pressure between 14 and 15 barg during the entire transfer process (the programmable logic controller (PLC) 140 will regulate speed, starts and steps of the boiling off gas compressor (BOC) 152). Once completed, valve XV-100 and valve XV-201 will be closed and the boiling off gas compressor (BOC) 152 will be stopped.

Main Control Loop d: Control loop for equalization of the vehicle tank (cargo tank) (TAV) 250 with the liquefied natural gas (LNG) storage Isotank 210:

The process for equalization of the vehicle tank (cargo tank) (TAV) 250 with the liquefied natural gas (LNG) storage Isotank 210 begins with the connection of the vehicle tank (cargo tank) (TAV) 250 to LNG/CNG system. The equalization sequence will depend on the condition that the vehicle tank (cargo tank) (TAV) 250 is in. This condition will be defined according to the pressure and temperature values defined by a pressure transmitter PT-400 and a temperature transmitter TT-400. The pressure of the liquefied natural gas (LNG) storage Isotank 210 will be supplied by the pressure transmitter PT-010.

As previously presented, three (3) different conditions may be presented:
Tank in daily use (cryogenic temperature/equilibrium pressure).
Empty tank (room temperature/atmospheric pressure).
Pressurized tank (temperature close to room/pressure close to the PSV set).

For the first case, the tank pressure must be regulated to 10 barg. So, if higher, the tank pressure must be regulated at 10 barg, sending liquefied natural gas (LNG) to the liquefied natural gas (LNG) storage Isotank 210 through a pressure control valve PCV-400; otherwise, no action will be taken. Once the pressure is regulated the solenoid valve that controls the pressure control valve (PCV) will de-energize, to prevent the pressure control valve (PCV) from opening during the charging process.

For the last two cases, the vehicle tank (cargo tank) (TAV) 250 will be equalized with the liquefied natural gas (LNG) storage Isotank 210 through valve XV-400. Once the pressures indicated by the pressure transmitter PT-400 and the pressure transmitter PT-010 equalize, valve XV-400 will close, being the vehicle tank (cargo tank) (TAV) 250 is ready for the loading process.

Main Control Loop e: Control loop for loading of vehicle tank (cargo tank) (TAV) 250:

The process of loading the vehicle tank (cargo tank) (TAV) 250, like the equalization process, will depend on the initial condition of the vehicle tank (cargo tank) (TAV) 250. The procedure in each case will be carried out according to what is specified in step f (step of loading the vehicle tank (cargo tank) (TAV) 250) presented above.

The instruments that will indicate the conditions of the liquid being loaded will be the pressure transmitter PT-300 and the temperature transmitter TT-300, while the pressure transmitter PT-400 and temperature transmitter TT-400 will indicate the status of the vehicle tank (cargo tank) (TAV) 250.

To enable the transfer of liquefied natural gas (LNG), valve XV-300 will open. To vent the vehicle tank (cargo tank) (TAV) 250 to the liquefied natural gas (LNG) storage Isotank 210 valve XV-400 will be used (If controlled venting is required, the pressure control valve (PCV) PCV-400 may be used)

The boiling off gas compressor (BOC) 152 will maintain a pressure of 15 barg in the liquefied natural gas (LNG) conditioning tank 150 during the entire load (following the process specified in point 3.d.) measured by pressure transmitter PT-020.

The transferred mass flow will be calculated by the Programmable Logic Controller (PLC), according to the measurement provided by weight transmitters WT-021, WT-022 and WT-023 located in the liquefied natural gas (LNG) conditioning tank 150 supports.

At the end of the loading process two variables are possible:
Abrupt decrease in load mass flow rate.
Pressure within the vehicle tank (cargo tank) (TAV) 250 equals 15.5 Barg (pressure transmitter PT-400).

Main Control Loop f: Control loop for transferring LNG from the vehicle tank (cargo tank) (TAV) 250 to the liquefied natural gas (LNG) storage Isotank 210:

To start the transfer between the vehicle tank (cargo tank) (TAV) 250 and the liquefied natural gas (LNG) storage Isotank 210, the pressure indicator PI-010 (Storage) and the pressure indicator PI-C01 (cistern tank of the vehicle tank (cargo tank) (TAV) 250) must first be compared. If the pressure within the liquefied natural gas (LNG) storage Isotank 210 is higher than the pressure within the cistern tank or the vehicle tank (cargo tank) (TAV) 250, the pressure must be equalized first by opening valve XV-100 and valve XV-601, until the pressure indications read the same. When the pressure in the liquefied natural gas (LNG) storage Isotank 210 is less than or equal to the pressure within the cistern tank or the vehicle tank (cargo tank) (TAV) 250, valve XV-601 will be closed, valve XV-600 will be opened and the boiling off gas compressor (BOC) 152 will be started to generate a pressure differential of 1 bar. When that value is reached, valve XV-500 will open allowing transfer of the liquefied natural gas (LNG) between the vehicle tank (cargo tank) (TAV) 250 and the liquefied natural gas (LNG) storage Isotank 210.

The programmable logic controller (PLC) 140 will compare the pressures provided by the pressure indicator PI-010 (Storage) and the pressure indicator PI-C01 (cistern tank of the cargo tank 250) at all times (constantly) and will adjust the speed of the boiling off gas compressor (BOC) 152, in order to maintain the desired differential pressure.

Likewise, when the transfer starts, the storage level indication must be noted. (This indication will be calculated by the Programmable Logic Controller (PLC) according to the values provided by the weight transmitters WT-011, WT-012 and WT-013 located on the supports of the container).

This transfer process will stop when the level of liquid in the storage reaches its maximum or when the cistern level reaches its minimum. Then the compressor will be stopped and all the valves will be closed.

Once the liquid load is complete, the cistern tank pressure must be returned to its initial value. For this, the pressures indicated by the PT-001 (Cistern Tank), PT-010 (storage) and PT-020 (Conditioning Tank (TAC)) will be compared. The vapor line of the cistern tank will be connected to the tank that is at the lowest pressure (opening the XV-600 and XV-200 in the case of storage and the XV-600 and XV-201 in the case of the Conditioning Tank (TAC)).

If with this procedure the pressure in the cistern does not reach its target value, the compressor is started and the corresponding valves according to the destination tank will be opened, until the required pressure is reached. Once reached, the compressor will stop, and all valves and the cistern will be disconnected.

Main Control Loop g: Control loop for auxiliary systems:

I. Compressed Air

The LNG/CNG system will not have an air compression system, but will take air from a line available at the installation site. Within its cabin, it will have a maintenance unit and a lung that will feed the solenoid valves.

In the event that the pressure indicator PI-A01 is a low pressure, the system will take actions described in the cause-effect matrix presented above, in order to ensure the installation.

An associated instruments diagram is presented in FIG. 16E.

The following are the various emergency systems associated with the LNG/CNG system and presented in FIG. 22:
The emergency system includes emergency push or stop buttons, at least one gas detector, at least one flame detector and a CO2 extinguishing system.
HS-001 provides an emergency stop button, which is provided to take the actions described in the cause-effect matrix.
HS-002 provides a fire emergency button, which is provided to take the actions described in the cause-effect matrix.
HS-003 provides an emergency stop override, which is provided to take the actions described in the cause-effect matrix.
B-001 provides a first audible alert, which is provided to notify an operator of a potential issue needing investigation.
B-002 provides a second audible alert, which is provided to notify an operator of a potential issue needing investigation. The first audible alert and the second audible alert may have different tones, different volumes, different alerts and the like to help an operator identify the potential issue, the severity of an issue, and the like while remaining distant from the system.
GD-001 provides a gas detector, which is provided to take the actions described in the cause-effect matrix.
FD-001 provides a flame detector, which is provided to take the actions described in the cause-effect matrix.
EV-F01 is a solenoid valve of the fire extinguisher, which is provided to take the actions described in the cause-effect matrix.
PS-F01 is pressure switch of the fire extinguisher, which is provided to take the actions described in the cause-effect matrix.

The LNG/CNG system includes a plurality of ventilation taps throughout the plumbing arrangement. The ventilation taps are identified by an irregular pentagon (resembling a house) and having a unique identifier located therein. Each ventilation tap unique identifier is presented in a form of a letter “V” follow by a unique reference numeral; more specifically, V01 through V12. The ventilation taps V01 through V12 are preferably arranged to collect the gas being discharged, as illustrated in FIG. 16G, where the discharged gas is exhausted through a single exhaust, such as the vent pipe 159. This arrangement provides control and safety over the discharged outgas of the natural gas.

The logic behind the decisions to activate or deactivate the boiling off gas compressor (BOC) 152 is presented in FIG. 16H. The logic is determined by the programmable logic computer (PLC) 140. Details of the specifications and operating parameters associated with each of the liquefied natural gas (LNG) conditioning tank 150, the liquefied natural gas (LNG) storage Isotank 210, and the boiling off gas compressor (BOC) 152 are presented in FIG. 17.

It will be understood that the embodiments shown in the drawings and described above are merely for illustrative purposes, and are not intended to limit the scope of the invention, which is defined by the claims, which follow as interpreted under the principles of patent law including the Doctrine of Equivalents.

For example, it is understood that any process can be used to determine if the pressure between two points is equalized.

### REFERENCE ELEMENT LIST

| Ref. No. | Description |
|---|---|
| 100 | modular multi-fueling platform |
| 100 | modular multi-fueling platform |
| 110 | enclosure |
| 111 | frame |
| 112 | front panel |
| 114 | rear panel |
| 115 | rear panel vent |
| 116 | roof panel |
| 117 | roof airflow aperture |
| 118 | base |
| 120 | first side panel |
| 122 | first side door |
| 124 | first side door handle |
| 126 | first side door vent |
| 130 | second side panel |
| 132 | second side door |
| 134 | second side door handle |
| 136 | second side door vent |
| 140 | programmable logic computer (PLC) |
| 142 | display |
| 144 | first user input component |
| 146 | second user input component |
| 150 | liquefied natural gas (LNG) conditioning tank |
| 152 | boiling off gas compressor (BOC) |
| 153 | compressed natural gas (CNG) to liquefied natural gas |
| | (LNG) compressor |
| 154 | heat exchanger |
| 155 | heat exchanger |
| 156 | heater |
| 158 | electric motor |
| 159 | vent pipe |
| 170 | vapor transfer line to between Isotank, conditioning tank |
| | and cargo tank |
| 171 | vapor transfer line to between Isotank, conditioning tank |
| | and cargo tank |
| 172 | liquefied natural gas (LNG) transfer line between Isotank |
| | and cargo tank |
| 173 | liquefied natural gas (LNG) transfer line between Isotank |
| | and cargo tank |
| 174 | liquefied natural gas (LNG) transfer line between Isotank |
| | and conditioning tank |
| 175 | liquefied natural gas (LNG) transfer line between Isotank |
| | and conditioning tank |
| 182 | liquefied natural gas (LNG) filling line to vehicle tank |
| 184 | vapor vent line from vehicle tank |
| 186 | liquefied natural gas (LNG) to storage tank transfer line |
| 190 | inlet to compressor cylinder 1 |
| 192 | inlet to compressor cylinder 2 |
| 194 | outlet from compressor cylinder 1 |
| 196 | outlet from compressor cylinder 2 |
| 200 | liquefied natural gas (LNG) storage Isotank assembly |
| 210 | liquefied natural gas (LNG) storage Isotank |
| 212 | liquefied natural gas (LNG) storage Isotank cylindrical |
| | sidewall |
| 214 | liquefied natural gas (LNG) storage Isotank front end wall |
| 216 | liquefied natural gas (LNG) storage Isotank rear end wall |
| 220 | liquefied natural gas (LNG) storage Isotank support frame |
| 222 | liquefied natural gas (LNG) storage Isotank support frame |
| | base |
| 224 | liquefied natural gas (LNG) storage Isotank support frame |
| | forward structure |
| 226 | liquefied natural gas (LNG) storage Isotank support frame |
| | rearward structure |
| 227 | liquefied natural gas (LNG) storage Isotank support frame |
| | rearward structure circumferential flange |
| 230 | liquefied natural gas (LNG) storage Isotank - liquefied |
| | natural gas (LNG) transfer coupling |
| 231 | liquefied natural gas (LNG) storage Isotank - liquefied |
| | natural gas (LNG) transfer valve |
| 232 | liquefied natural gas (LNG) storage Isotank - vapor |
| | transfer coupling |
| 233 | liquefied natural gas (LNG) storage Isotank - vapor |
| | transfer valve |
| 234 | liquefied natural gas (LNG) storage Isotank - liquefied |
| | natural gas (LNG) transfer coupling |
| 235 | liquefied natural gas (LNG) storage Isotank - liquefied |
| | natural gas (LNG) transfer valve |
| 236 | liquefied natural gas (LNG) storage Isotank - liquefied |
| | natural gas (LNG) transfer coupling |
| 237 | liquefied natural gas (LNG) storage Isotank - liquefied |
| | natural gas (LNG) transfer valve |
| 250 | cargo tank |
| 400 | component legend |
| 402 | stream flow direction |
| 404 | manual valve |
| 406 | needle valve |
| 408 | check valve |
| 410 | mass flow meter |
| 412 | break away valve |
| 414 | filter “Y” |
| 416 | cap |
| 420 | air cooler/heater |
| 422 | electric heater |
| 424 | instrument air treatment unit (filter, lubrication and |
| | regulation) |
| 426 | compressor |
| 430 | safety valve |
| 432 | solenoid valve |
| 434 | actuated on-off valve |
| 440 | drain connection |
| 442 | hose |
| 444 | diffuser |
| 450 | vessel |
| 460 | on page connector |
| 462 | stream code |
| 464 | off page connector |
| 470 | process lines references |
| 472 | liquefied natural gas (LNG) line |
| 474 | boil off line |
| 476 | air line |
| 478 | cryogenic insulated line indication |
| 480 | cargo tank signals and connectivity map |
| 482 | liquefied natural gas (LNG) cargo tank connection |
| 484 | vapor vent line cargo tank connection |
| 486 | liquefied natural gas (LNG) cargo tank connection |
| 500 | operational process overview flow diagram |
| 510 | vehicle tank (TAC) to system process |
| 511 | connect liquefied natural gas (LNG) discharge lines |
| | step |
| 512 | connect boil off gas (BOG) return lines step |
| 513 | open valves for each line step |
| 514 | vehicle tank initial state pressure and temperature |
| | acquisition step |
| 515 | cold liquefied natural gas (LNG) or hot liquefied |
| | natural gas (LNG) decision step |
| 520 | storage tank to conditioning tank (TAC) transfer |
| | process |
| 521 | storage tank and conditioning tank (TAC) pressure |
| | comparison step |
| 522 | pressure of conditioning tank (TAC) greater than |
| | pressure of storage tank decision step |
| 523 | conditioning tank (TAC) and storage pressure |
| | equalization step |
| 524 | start compressor to generate pressure differential |
| | of 1 Bar step |
| 525 | is conditioning tank (TAC) full decision step |
| 526 | stop compressor and disable liquid transfer line |
| | step |
| 530 | liquefied natural gas (LNG) conditioning process |
| 531 | conditioning tank (TAC) is fully loaded state |
| 532 | start compressor step |
| 533 | draw boil off gas (BOG) from top of conditioning |
| | tank (TAC) step |
| 534 | pass drawn boil off gas (BOG) through heat exchanger |
| | step |
| 535 | re-inject heated boil off gas (BOG) into bottom of |
| | conditioning tank (TAC) step |
| 536 | determine if temperature of liquid natural gas (LNG) |
| | is at the final temperature decision step |
| 537 | stop compressor step |
| 540 | conditioning tank (TAC) pressurizing process |
| 541 | conditioning tank (TAC) is fully loaded state |
| 542 | stall compressor step |
| 543 | inject boil off gas (BOG) from storage tank into |
| | conditioning tank (TAC) step |
| 544 | determine if pressure of conditioning tank (TAC) is |
| | close to 15 Barg |
| 545 | stop compressor and disable liquid transfer line step |
| 550 | vehicle tank (TAC) and storage tank equalization process |
| 551 | lowering pressure in vehicle tank (TV) to receive liquid |
| | natural gas (LNG) from conditioning tank (TAC) step |
| 552 | determine current vehicle tank (TV) condition decision step |
| 552A | first considered vehicle tank (TV) condition (normal use) |
| 552B | second considered vehicle tank (TV) condition (empty tank) |
| 552C | third considered vehicle tank (TV) condition (pressurized |
| | tank) |
| 553B | equalization of vehicle tank (TAV) and storage tank (TAC) |
| | step |
| 553C | equalization of vehicle tank (TAV) and storage tank (TAC) |
| | step |
| 554 | determine if pressure of vehicle tank (TAV) is greater |
| | than 10 Barg decision step |
| 555 | depressurize vehicle tank (TAV) through PCV until reaching |
| | 10 Barg step |
| 556 | close boil off gas (BOG) line to storage step |
| 557 | vehicle valve remain open notation |
| 560 | vehicle tank (TAV) charging process |
| 560A | vehicle tank (TAV) charging process (first set of tank |
| | conditions - normal use) |
| 560B | vehicle tank (TAV) charging process (second set of tank |
| | conditions - empty tank) |
| 560C | vehicle tank (TAV) charging process (third set of tank |
| | conditions - pressurized tank) |
| 561 | enable discharge line towards vehicle tank (TAV) step |
| 562 | flow liquid natural gas (LNG) into vehicle tank (TAV) |
| | step |
| 567A | determine if flow of liquid natural gas (LNG) at exit |
| | abruptly decreases decision step |
| 567B | determine if pressure in vehicle tank (TAV) reaches |
| | predetermined value decision step |
| 568 | determine if load is considered complete on vehicle tank |
| | indicator decision step |
| 569 | close vehicle liquid natural gas (LNG) and boil off gas |
| | (BOG) lines step |
| 571A | enable boil off gas (BOG) flow from vehicle tank (TAV) |
| | to storage tank step |
| 572A | open liquid natural gas (LNG) charge line to vehicle |
| | tank (TAV) step |
| 572 | load a predetermined mass of liquid natural gas (LNG) |
| | and close charge line step |
| 573 | equalize vehicle tank (TAV) and storage tank pressures |
| 574 | determine if desired vehicle tank (TAV) temperature is |
| | met decision step |
| 575 | disable boil off gas (BOG) line step |
| 576A | enable vehicle tank (TAV) liquid discharge line step |
| 576B | flow liquid natural gas (LNG) into vehicle tank (TAV) |
| | step |
| 577A | determine if flow of liquid natural gas (LNG) at exit |
| | abruptly decreases decision step |
| 577B | determine if pressure of vehicle tank (TAV) reaches |
| | predetermined value decision step |
| 578 | determine if load is considered complete on vehicle tank |
| | indicator decision step |
| 579 | close vehicle liquid natural gas (LNG) and boil off gas |
| | (BOG) lines step |
| 581A | enable boil off gas (BOG) flow from vehicle tank (TAV) |
| | to storage tank step |
| 581B | enable liquid natural gas (LNG) charge line to vehicle |
| | tank (TAV) step |
| 581C | flow liquid natural gas (LNG) to vehicle tank (TAV) step |
| 582 | boil off gas (BOG) flows towards storage tank step |
| 583 | determine if pressure between vehicle tank (TAV) and storage |
| | tank is equalized decision step |
| 588 | determine if load is considered complete on vehicle tank |
| | indicator decision step |
| 589 | close vehicle liquid natural gas (LNG) and boil off gas |
| | (BOG) lines step |
| 590 | supply tank to storage tank process |
| 591 | connect liquid and steam lines from supply tank to system |
| | step |
| 592 | compare pressure between supply tank and storage tank step |
| 593 | determine if pressure of the supply tank is greater than the |
| | pressure of the storage tank decision step |
| 594 | equalize pressure between supply tank and storage tank step |
| 595 | start compressor to obtain pressure differential between |
| | storage tank and supply tank of 1 Bar |
| 596 | determine if storage tank is full decision step |
| 597 | stop compressor and disable liquid transfer line step |

What is claimed is:

1. A method of transferring liquefied natural gas (LNG) comprising steps of:
connecting a vehicle tank to a system, the system comprising:
a liquefied natural gas (LNG) conditioning tank,
a compressor,
plumbing,
a plurality of valves, and
a programmable logic controller (PLC);
transferring liquefied natural gas (LNG) from a storage tank to the conditioning tank;
conditioning the liquefied natural gas (LNG) within the conditioning tank;
pressurizing the conditioning tank;
equalizing pressure between the vehicle tank and the storage tank; and
charging the vehicle tank.

2. The method of transferring liquefied natural gas (LNG) as recited in claim 1, the method further comprising a step of:
identifying a desired condition of the liquefied natural gas (LNG), wherein the desired condition of the liquefied natural gas (LNG) defines a subsequent equalization and charging processes of the vehicle tank.

3. The method of transferring liquefied natural gas (LNG) as recited in claim 1, wherein the process of transferring the liquefied natural gas (LNG) from the storage tank to the conditioning tank is accomplished by generating a pressure difference between the storage tank and the liquefied natural gas (LNG) conditioning tank through the compressor.

4. The method of transferring liquefied natural gas (LNG) as recited in claim 1, wherein the process of conditioning the liquefied natural gas (LNG) within the conditioning tank is accomplished by steps of:
a) starting the compressor;
b) drawing boil off gas (BOG) from a top of the conditioning tank;
c) passing the drawn boil off gas (BOG) through the a heat exchanger;
d) re-injecting the heated boil off gas (BOG) into a bottom of the conditioning tank; and
e) repeating steps b, c, and d until a temperature of the liquefied natural gas (LNG) reaches a final temperature.

5. The method of transferring liquefied natural gas (LNG) as recited in claim 1, wherein the process of pressurizing the conditioning tank is accomplished by steps of:
a) obtaining a condition where the conditioning tank is fully loaded;
b) starting the compressor;
c) injecting boil off gas (BOG) from the storage tank into the conditioning tank until a pressure within the conditioning tank is close to 15 Barg.

6. The method of transferring liquefied natural gas (LNG) as recited in claim 1, the method further comprising a step of determining a current condition of the vehicle tank, wherein the condition is one of:
daily use;
empty; or
pressurized.

7. The method of transferring liquefied natural gas (LNG) as recited in claim 6, wherein the process of charging the vehicle tank is accomplished by steps of:
a) determining the tank to be in a condition categorized as daily use;
b) enabling a liquid discharge line towards the vehicle tank;
c) flowing liquefied natural gas (LNG) into the vehicle tank;
d) continuing the step of flowing liquefied natural gas (LNG) into the vehicle tank until at least one of:
flow of the liquefied natural gas (LNG) abruptly decreases, and
a pressure within the vehicle tank reaches a predetermined value
e) in a condition where the vehicle tank is determined to have an incomplete load, the process continues with step c; and
f) in a condition where the vehicle tank is determined to have a complete load, the process closes the liquefied natural gas (LNG) line to the vehicle tank and the boil off gas (BOG) line to the vehicle tank.

8. The method of transferring liquefied natural gas (LNG) as recited in claim 6, wherein the process of charging the vehicle tank is accomplished by steps of:
a) determining the tank to be in a condition categorized as empty;
b) enabling a boil off gas (BOG) line from the vehicle tank towards the storage tank;
c) enabling a liquid charge line towards the vehicle tank;
d) loading a certain mass of liquefied natural gas (LNG) into the vehicle tank and cutting the charge line;
e) equalizing the pressure of the vehicle tank and the storage tank;
f) in a condition where a temperature of the liquefied natural gas (LNG) stored within vehicle tank is below a desired temperature, the process returns to step c;
g) in a condition where a temperature of the liquefied natural gas (LNG) stored within vehicle tank is at a desired temperature, the boil off gas (BOG line from the vehicle tank is disabled;
h) enabling a liquid discharge line towards the vehicle tank;
i) flowing liquefied natural gas (LNG) into the vehicle tank;
j) continuing the step of flowing liquefied natural gas (LNG) into the vehicle tank until at least one of:
flow of the liquefied natural gas (LNG) abruptly decreases, and
a pressure within the vehicle tank reaches a predetermined value
k) in a condition where the vehicle tank is determined to have an incomplete load, the process continues with step c; and
l) in a condition where the vehicle tank is determined to have a complete load, the process closes the liquefied natural gas (LNG) line to the vehicle tank and the boil off gas (BOG) line to the vehicle tank.

9. The method of transferring liquefied natural gas (LNG) as recited in claim 6, wherein the process of charging the vehicle tank is accomplished by steps of:
a) determining the tank to be in a condition categorized as pressurized;
b) enabling a boil off gas (BOG) line from the vehicle tank towards the storage tank;
c) flowing boil off gas (BOG) towards the storage tank;
d) in a condition where a pressure of the liquefied natural gas (LNG) stored within the vehicle tank and a pressure of the liquefied natural gas (LNG) stored within the storage tank are not equalized, the process continues with step c;
e) in a condition where a pressure of the liquefied natural gas (LNG) stored within the vehicle tank and a pressure of the liquefied natural gas (LNG) stored within the storage tank are equalized, the process proceeds to step f;
f) enabling a liquid charge line towards the vehicle tank;
g) flowing liquefied natural gas (LNG) into the vehicle tank;
h) continuing the step of flowing liquefied natural gas (LNG) into the vehicle tank until the vehicle tank is determined to have a complete load;
i) in a condition where the vehicle tank is determined to have a complete load, the process closes the liquefied natural gas (LNG) line to the vehicle tank and the boil off gas (BOG) line to the vehicle tank.

10. The method of transferring liquefied natural gas (LNG) as recited in claim 1, wherein the process of equalizing pressure between the vehicle tank and the storage tank is accomplished by steps of:
a) lowering a pressure within the vehicle tank;
b) equalizing the pressure within the vehicle tank and a pressure within the storage tank; and
c) closing a boil off gas line to the storage tank.

11. A integrated mod system liquefied natural gas (LNG) transfer, storage, and delivery system comprising:
a modular multi-fueling platform, including:
a liquefied natural gas (LNG) conditioning tank,
a compressor,
plumbing,
a plurality of valves,
a programmable logic controller (PLC);
at least one pressure sensing transmitter, and
at least one temperature sensing transmitter, and
a liquefied natural gas (LNG) storage Isotank assembly, including:
a pressurized liquid container, and
a thermally insulating material arranged to minimize thermal release from LNG stored within the LNG storage Isotank assembly,
wherein the LNG storage Isotank assembly and the conditioning tank are in fluid communication with one another,
wherein the compressor is arranged in fluid communication between the LNG storage Isotank assembly and the conditioning tank,
wherein valves are arranged to control flow between the LNG storage Isotank assembly and the conditioning tank,
wherein the at least one pressure sensing transmitter and the at least one temperature sensing transmitter are locating to obtain a pressure and a temperature and provide the pressure and the temperature to the PLC,
wherein the PLC is programmed to operate the compressor and one or more valves of the plurality of valves to convert boil off gas to liquefied natural gas (LNG) and to create a pressure differential between two tanks to transfer liquefied natural gas (LNG) from a first tank to a second tank, wherein the first tank is one of the LNG storage Isotank assembly, the LNG conditioning tank, and a cargo tank.

12. The integrated modular system liquefied natural gas (LNG) transfer, storage, and delivery as recite in claim 11, the LNG storage Isotank assembly further comprising:
a line arranged to draw material from an upper region of the pressurized liquid container; and
a line arranged to inject material into a lower region of the pressurized liquid container.

13. The integrated modular system liquefied natural gas (LNG) transfer, storage, and delivery as recite in claim 11, the conditioning tank further comprising:
a line arranged to draw material from an upper region of the conditioning tank; and
a line arranged to inject material into a lower region of the conditioning tank.

14. The integrated modular system liquefied natural gas (LNG) transfer, storage, and delivery as recite in claim 11, the pressurized liquid container comprising:
a tubular sidewall,
a first end wall,
a second end wall,
wherein the first end wall is assembled to a first end of the tubular sidewall and the second end wall is assembled to a second end of the tubular sidewall forming the pressurized liquid container.

15. The integrated modular system liquefied natural gas (LNG) transfer, storage, and delivery as recite in claim 11, the pressurized liquid container comprising:
a cylindrically shaped tubular sidewall,
a first end wall,
a second end wall,
wherein the first end wall is assembled to a first end of the cylindrically shaped tubular sidewall and the second end wall is assembled to a second end of the tubular sidewall forming the pressurized liquid container.

16. The integrated modular system liquefied natural gas (LNG) transfer, storage, and delivery as recite in claim 11, the modular multi-fueling platform further comprising:
a heat exchanger;
wherein the heat exchanger is arranged to provide heat to boil off gas (BOG) extracted from at least one of the LNG storage Isotank assembly and the LNG conditioning tank.

17. The integrated modular system liquefied natural gas (LNG) transfer, storage, and delivery as recite in claim 11, wherein the heat exchanger obtains an elevated temperature from at least one of:
a) ambient air, and
b) a heating element.

18. The integrated modular system liquefied natural gas (LNG) transfer, storage, and delivery as recite in claim 11, wherein a portion of the plumbing includes cryogenic isolation.

19. The integrated modular system liquefied natural gas (LNG) transfer, storage, and delivery as recite in claim 11, wherein the plumbing includes lines for transport of liquefied natural gas (LNG), transport of boil off gas (BOG), transport of air, and portions that include cryogenic isolation.
